(19) United States
(12) Patent Application Publication
(10) Pub. No.: US 2006/0075017 A1
(43) Pub. Date: Apr. 6, 2006

(54) Internet studying system and the studying method

(76) Inventors: Young-Hee Lee, Ok-Dong (KR); Yong-Ok Lee, Busan City (KR)

Correspondence Address: CANTOR COLBURN, LLP, 55 GRIFFIN ROAD SOUTH, BLOOMFIELD, CT, 06002, US

(21) Appl. No.: 10/530,744

(22) PCT Filed: Oct. 4, 2003
(86) PCT No.: PCT/KR03/02043

§ 371 Date: Apr. 8, 2005

(30) Foreign Application Priority Data
Oct. 9, 2002 (KR) 10-2002-0061601
Sep. 27, 2003 (KR) 10-2003-0067220

(51) Int. Cl. G06F 15/16; G06F 17/00; G09B 3/00

(52) U.S. Cl. 709/203; 434/322; 707/104.1

(57) ABSTRACT

The present invention for supplying an custom-made education system on internet is composed of conceptual contents subdivided by the minimum unit, problem groups related to each conceptual content, and problem explanations for each problem, so that they can be reconfigured. In addition that, it has the space on line for each learner's learning career record which are used for offering the best learning contents by considering each learner's ability.

### TECHNICAL FIELD

The present invention relates to an Internet learning system and method thereof which provides the contents of a subject to be learned, related test problems, etc. to a user who joined as a member so that he or she can efficiently study using the Internet.

### BACKGROUND ART

An increase in the use of computer application technologies and the Internet causes lots of change in all the aspects of society. In particular, in the field of education, remote education, etc., which is supported by the computer and the Internet, has been actively made. More particularly, some makes an effort to implement custom-made education considering characteristics of each learner. Further, in view of education media, there is an attempt to increase the learning effect through active utilization of the Internet and multimedia data. These attempts have been widely applied in the field of the learning for specific learners or of in-house education.

These changes paved the way for a shift from the existing face-to-face education method to a remote learning method in the learning method.

In suit with this trend, the contents that were already broadcasted through radio or cable broadcasting, which are the existing broadcasting mediums, are now provided to the learner in the form of video on demand (VOD) through the Internet web site. Such remote education, however, is not different from the face-to-face education method in that it provides all the learners with learning materials of the same contents, and has a problem that it does not make the best use of the advantages of remote education.

In order to overcome these problems, there was proposed a learning method using the Internet and system thereof, wherein a users learning ability is evaluated using a database consisting of grounds of databased problems, and adequate custom-made problems extracted from the database according to the evaluation are provided to the user, thereby improving learning efficiency of each person (see Korean Patent Appl. Nos. 2000-28862, 2002-13592 and 2001-68374).

In these prior arts, however, plural groups of problems for the fields that a learner must study are selected/provided to the learner for solving. The results are then scored. Therefore, in the prior arts, only the learner's generalized learning ability is determined. In addition, the learning contents presented after the evaluation belong to a level that presents groups of problems whose degree of difficulty is generally adjusted. Therefore, the prior arts do not have a function of evaluating the degree of full knowledge for an individual problem and does not evaluate the ability of the learner for detailed learning contents.

Problems in the prior arts will now be described in more detail.

First, a learning evaluation method is a method wherein a learning form of a next step is determined based on examination records of a learner for a group of tests. This method is based on general contents called the examination records. In this method, a case where portions that the learner already knows may be tested redundantly takes place inevitably.

Second, in the above method, only a learning method wherein a subject learning is generally accessed through the test is attempted. It is fundamentally difficult that this method is applied to custom-made learning covering basic school curriculum contents or explanations. For example, a private teacher for an each lesson teaches in detail portions that the learner does not understand including school curriculum contents or explanations as well as problems for the leaner. However, the above-mentioned methods do not suggest or attempt the private teaching method.

If it is desired to implement a learning system that can provide custom-made education to a certain extent that a capable private teacher for an individual lesson teaches the learner, a deep research into how the school curriculum contents and explanations can be databased must be made, a method of databasing groups of problems related to them has to be contrived, and a general and systematic access to a learning progress method to cover them must be made.

Third, the learning systems of the prior arts have excessively lots of incompleteness in their learning methods. This is caused by the method for generally determining even next learning contents based on the test records being a general result as mentioned in the first problem. These systems do not have means for specifying the fields that the learner does not understand. Thus, even if the learner gets the records of over a given level and proceeds to a next step or a next unit, it may be difficult to see that the learner understood all the contents of school curriculums in the previous step. That is, it could be said that there will be lots of portions that that learner does not understand.

At this time, even if he or she is a private teacher, it would be very difficult to proceed to a next step after the teacher lets the learner to have full knowledge of portions that the learner does not know. In the Internet learning system using the computer, however, this can be accomplished through the use of the computer having fine and exact work performance capability and the technology of the Internet The Internet learning system can have significant advantages over the learning of a capable private teacher, while offsetting the fact that a custom-made degree of the Internet learning system may slightly fall below the private teacher.

### DISCLOSURE OF INVENTION

The present is directed to a new Internet learning system and method thereof, and more particularly, to a system and method, which has a learning effect as if a capable private teacher for each lesson teaches only a specific learner off-line although many learners study at the same time. Further; in view of fineness and completeness of the learning method, it is expected that the present system and method can have a learning effect higher than those offered by the private teacher off-line.

The present invention can be applied to all subjects having a curriculum range that can be standardized without the limitations to the forms and contents of learning. In other words, the present invention can be applied to all the subjects of the elementary, middle school and high school curriculums since their curriculums are predetermined, and various qualifying examinations such as a driver's license, a licensed real estate agent, a patent attorney, an attorney and the like. In the above, the range of the curriculums indicates a range that can be generally defined not a range that is completely defined. The depth of knowledge covered may be different depending on its intension, purpose, etc.

### BRIEF DESCRIPTION OF DRAWINGS

Further objects and advantages of the invention can be more fully understood from the following detailed description taken in conjunction with the accompanying drawings in which:

FIG. 1 illustrates the entire construction of an Internet learning system according to a preferred embodiment of the present invention;

FIG. 2 illustrates a detail construction of the Internet learning system shown in FIG. 1 according to a preferred embodiment of the present invention;

FIG. 3 is a table showing the concept of a conceptual contents database 8-1, a problem database 8-2 and a problem explanation file database 8-3, and the relationship among them according to a preferred embodiment of the present invention,

FIG. 4-a shows a packet structure of a conceptual content data according to a preferred embodiment of the present invention;

FIG. 4-b shows a packet structure of a conceptual content data according to another preferred embodiment of the present invention;

FIG. 5 shows a packet structure of a problem data according to a preferred embodiment of the present invention;

FIG. 6-a shows a packet structure of a problem explanation file data according to a preferred embodiment of the present invention;

FIG. 6-b shows a packet structure of a problem explanation file data according to another preferred embodiment of the present invention;

FIG. 7 shows a packet structure of a learning dictionary data according to a preferred embodiment of the present invention;

FIG. 8 shows the construction of an individual learner learning information packet according to a preferred embodiment of the present invention;

FIG. 9 is a flowchart illustrating process steps of the Internet learning system according to a preferred embodiment of the present invention;

FIG. 10 is a flowchart illustrating a process of allowing a user to become a member and of allowing a new member to input his or her initial learning ability according to a preferred embodiment of the present invention;

FIG. 11 is a flowchart illustrating a process of setting a learning procedure according to a preferred embodiment of the present invention;

FIG. 11-1 shows a learning procedure table according to a preferred embodiment of the present invention;

FIG. 12 is a flowchart illustrating a process of automatically setting a learning step according to a preferred embodiment of the present invention;

FIG. 13 is a flowchart illustrating a learning progress step according to a preferred embodiment of the present invention;

FIG. 14 is a flowchart illustrating a process of reconfiguring a next step learning content according to a preferred embodiment of the present invention;

FIG. 15 is a flowchart illustrating a process of reconfiguring problems related to wrong problems according to a preferred embodiment of the present invention;

FIG. 16 is a flowchart illustrating a process of reconfiguring problems related to hit problems according to a preferred embodiment of the present invention;

FIG. 17 is a flowchart illustrating a process of automatically setting problems according to a preferred embodiment of the present invention;

FIG. 18 illustrates the entire construction of an Internet learning system according to another embodiment of the present invention;

FIG. 19 illustrates a detailed construction of the Internet learning system shown in FIG. 18 according to another embodiment of the present invention;

FIG. 20 illustrates the entire construction of an Internet learning system according to still another embodiment of the present invention; and

FIG. 21 illustrates a detailed construction of the Internet learning system shown in FIG. 20 according to still another embodiment of the present invention.

The Title of Key Elements in Figures

5001; classification code, 5002: medium classification code, 5002-a; grade code, 5002-b; subject code, 5003; code divided by the minimum unit, 5004; conceptual contents file code, 5005; degree of difficulty code, 5006; learning time, 5007; the number of the conceptual contents file packet bits, 5007-a; the number of packet bits, 5007-b; conceptual content, 5007-c; learning dictionary, 5010; problem-native code, 5011; the number of the problem file packet bits, 5011-a; the number of the problem explanation file packet bits, 5012-a; problem explanation file, 5009-a; the number of learning dictionary file packet bits, 5009-c; dictionary word code

### BEST MODE FOR CARRYING OUT THE INVENTION

It has been described in the above that a network on which the present invention is implemented is generally referred to as the Internet. However, the network may include various networks such as the Internet, the intranet, a local area network (LAN), etc. Examples of the computer network that can be used may include a wired network, a wireless network and a mobile network.

In explaining the construction of the present invention, how hardware elements, software components or a combination of them are constructed will be first described. Main characteristic components on which the present invention is based will be then explained. Finally, description on a learning flow will be given.

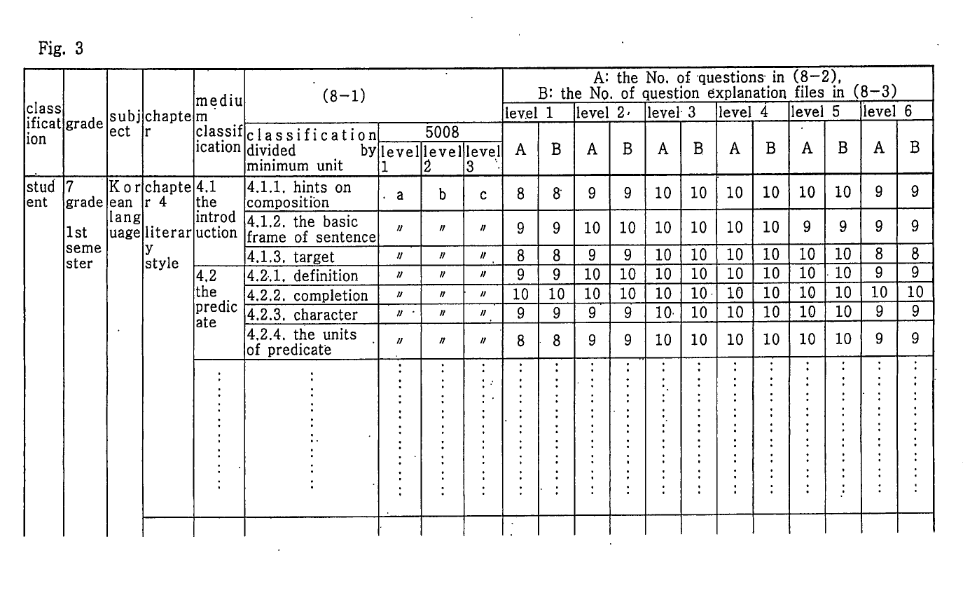

The whole contents of the main characteristic components according of the present invention will be first listed and each of the components will be then explained

| 1. | System Configuration | | |
|---|---|---|---|
| 2. | Configuration of Learning Material Database | | |
| | (1) | Introduction and Characteristics | |
| | (2) | Meaning of Minimum Unit | |
| | (3) | Conceptual Contents and Conceptual Contents | |
| | | Database 8-1 | |
| | (4) | Problem Database 8-2 and Problem Explanation File | |
| | | Database 8-3 | |
| | (5) | Explanation of Learning Contents Database Method | |
| | | through FIG. 3 | |
| 3. | Learning Information Database 6-2 and Learning Information | | |
| | Management Program 6-1 | | |
| | (1) | Learning Information Database 6-2 | |
| | (2) | Learning Information Management Program 6-1 | |
| | (3) | Learning Note Management Program 6-4 | |
| | (4) | Type of Utilization of Learned History, etc. | |
| 4. | Learning Plan Configuration Program 7-1 | | |
| 5. | Explanation on Progress Method of Learning through Example 5 | | |
| | (1) | Learner Conditions | |
| | (2) | Progress in Learning Information Management Server | |
| | | System 6 and Learning Progress Server System 7 | |
| | | \textcircled{1} | Learning Information Management Program 6-1 |
| | | \textcircled{2} | Learning Plan Configuration Program 7-1 |
| | | \textcircled{3} | Conceptual Contents Configuration Program 7-2 |
| | | \textcircled{4} | Step of Allowing the Learner to Learn Conceptual |
| | | | Contents Group Provided to Learner |
| | | \textcircled{5} | Problem Configuration Program 7-3 |
| | | \textcircled{6} | Learner's Test |
| | | \textcircled{7} | Test Scoring Program 7-4 |
| | | \textcircled{8} | Review of Studies on Wrong Problems Depending on |
| | | | Scoring Result |
| | (3) | Two-Step Learning | |
| | | \textcircled{1} | Problems to be Tested Again are Selected/Configured |
| | | | Considering Degree of Difficulty Taking Test Result of |
| | | | Learner Into Consideration, (Problem Configuration |
| | | | Program 7-3) |
| | | \textcircled{2} | Learner's Test on Reconfigured Problem Groups, |
| | | | Scoring and Review of Studies on Wrong Problems |
| | (4) | Third Step, Fourth Step . . . Learning | |
| | (5) | Completion of Learning | |
| | (6) | Relationship with Learning Information Database 6-2 | |
| 6. | Explanation on Progress Method of Learning Through Example 6 | | |
| | (1) | Setting | |
| | (2) | Learning method | |
| | | \textcircled{1} | If There is Time to Spare |

| | |
|---|---|
| \textcircled{2} \textcircled{2} | If There is No Time to Spare |

| | |
|---|---|
| 7. | Characteristics of Internet Educational System of Present |
| | Invention |

1. System Configuration

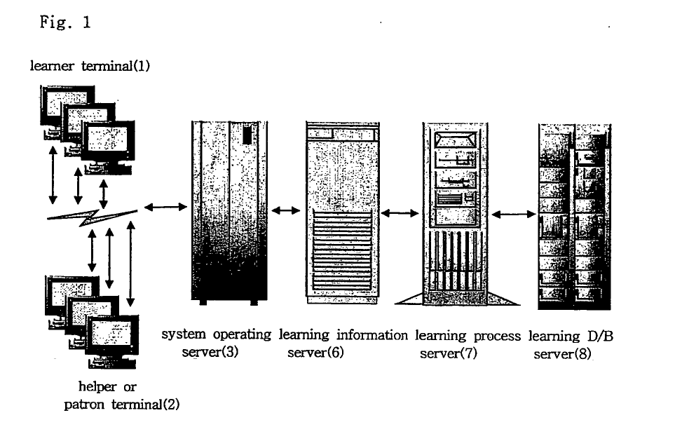

In the present invention, the system configuration may be classified mainly into five elements, as shown in FIG. 1. The first components are terminals 1 and 2 of a learner or a learning-related person such as a helper, a patron, etc. (hereinafter collectively referred to as “learner, etc.”), which are corresponding to interfaces through which the learner accesses the system over the Internet.

The invention of FIG. 1 is classified into four server systems, each of which includes a system operating server system 3, a learning information management server system 6, a learning progress server system 7 and a learning database server system 8.

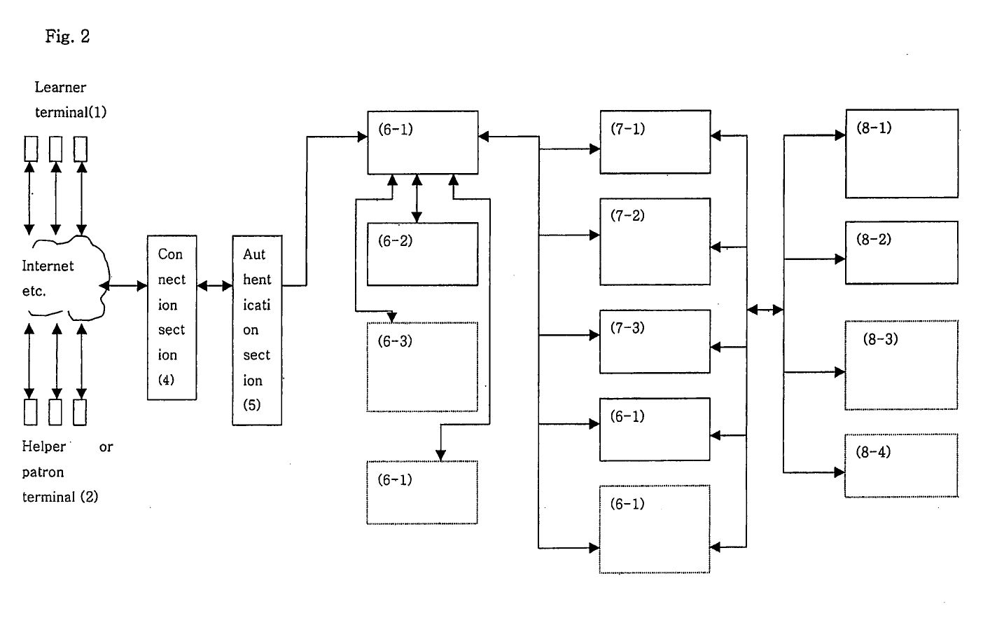

Each of the servers will be described in detail with reference to FIG. 2. The system operating server system 3 includes basically a connection section 4, an authentication section 5 and a billing section 9. The connection section 4, the authentication section 5 and the billing section 9 constituting the system operating server system 3 are technical components that have currently been used by a large number of Internet sites. The present invention can be implemented using these well-known means.

The learning information management server system 6 includes a learning information management program 6-1 and a learning information database 6-2. The server system 6 may further include a learner learning ability measurement program 6-3 and a learning note management program 6-4, if needed.

The learning progress server system 7 includes a conceptual contents configuration program 7-2, a problem configuration program 7-3, a test scoring program 7-4 and a problem explanation file configuration program 7-5. The server system 7 may further include a learning plan configuration program 7-1, if necessary.

Next, the learning database server system 8 includes a conceptual contents database 8-1, a problem database 8-2 and a problem explanation file database 8-3. The server system 8 may further include a learning dictionary database 8-4, if appropriate.

How these components are operated is described and shown in detail in the drawings in conjunction with the detailed description of the present invention. The construction of the components will now be described.

2. Construction of Learning Material Database

1) Introduction and Characteristics

In a database method used in the present invention, a first significant characteristic is that a conceptual contents file is produced to have the size of the minimum unit wherein only a single conception is contained in a single data file by segmenting learning contents by maximum, if the contents related to the contents explaining learning contents are to be databased. This will be explained with reference to FIG. 3.

FIG. 3 illustrates a specific learning range consisting of the concept of a single minimum unit. There is shown in FIG. 3 that 4. 1. 1, 4. 1. 2, . . . shown below “classification divided by the minimum unit” is one example of a learning content classification consisting of the minimum unit. This means that the content of a subject matter to explain or lecture the concept of the learning subject matter divided by this classification unit (hereinafter referred to as “conceptual content” and two or more conceptual content are referred to as “conceptual contents”) is produced. In other words, the learning content of the Internet learning system is subdivided and produced every conceptual content divided by the minimum unit.

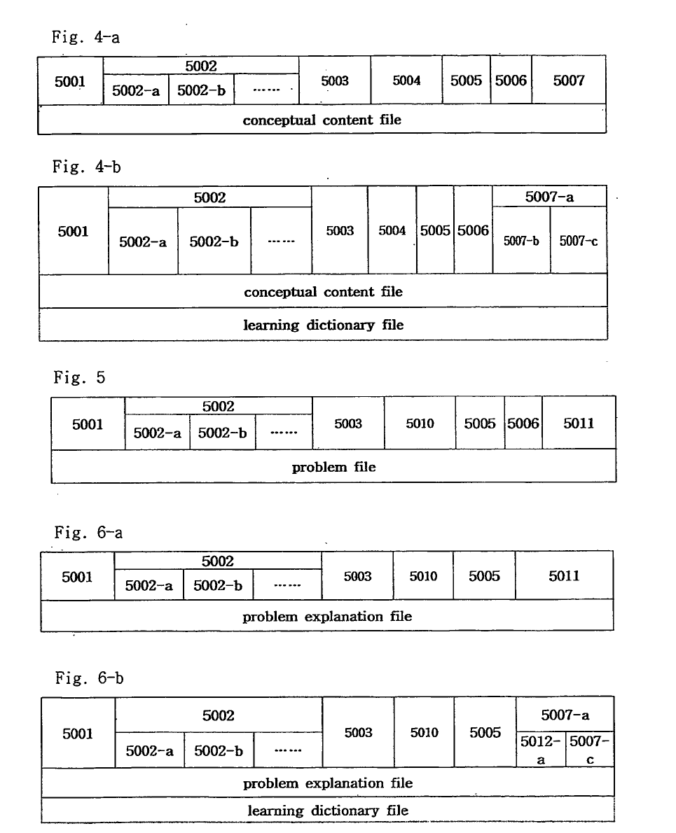

FIG. 4-a illustrates a packet structure of the conceptual content. Each conceptual content preferably includes a header wherein a classification code, a medium classification code such as a grade code, a subject code, etc., a code divided by the minimum unit, a conceptual contents file code, the degree of difficulty code and a learning time code are allocated with given bits, as shown in FIG. 3. Therefore, this classification can be variously changed depending on the necessity. At this time, it is preferred that allocation of the bits is determined using the number of the bits having a sufficient great number by the number of each item. If the conceptual contents data stored in the learning database are to be accessed by the learning progress server 7, corresponding conceptual contents data for the packet of FIG. 4-a can be accessed using the header data. Further, each conceptual content may have the number of a packet byte following the header so that the conceptual content having a given size can be efficiently stored and managed. The number of the packet byte may have a fixed number, if necessary, thus limiting only the maximum size of the conceptual contents.

FIG. 4-b shows the packet structure of the conceptual content data in which a learning dictionary explaining the meaning of words included in the conceptual content is attached to a corresponding conceptual content file in order to rapidly respond to a learner's request, in FIG. 4-a. At this time, the learning dictionary can be made to respond to the request of the learner in multi-steps. Eventually, the learning dictionary may be connected to the whole learning dictionary covering the entire as well as its conceptual content packet.

Such principle is applied to a problem file and a problem explanation file below. The conceptual content of FIG. 4-b includes a header wherein a classification code, a grade code, a subject code, a medium classification code, a more classified code, a code divided by the minimum unit, a conceptual content file code and the degree of difficulty code are allocated with given bits, as in FIG. 4-a. At this time, it is preferred that allocation of the bits is determined using the number of the bits having a sufficient great number by the number of each item. In the event that the conceptual contents data and the learning dictionary file stored in the learning database are accessed by the learning progress server 7, a corresponding conceptual content data and a corresponding learning dictionary file for the packet of FIG. 4-b can be accessed using the header data. Further, respective conceptual contents data and learning dictionary file may have the number of packet bytes following the header so that the conceptual contents having a given size can be efficiently stored and managed. The number of the packet byte may have a fixed number, if necessary, thus limiting only the maximum size of the conceptual contents. In the above, learning dictionary files related to the conceptual content can be connected every conceptual content. Each of the learning dictionary files has the same header data as each learning content. The header data may be connected to a portion to describe or explain the learning dictionary database or the conceptual contents using the same header data at the same time.

A second significant characteristic is that problem files related to the conceptual content are connected every conceptual content, depending on a case. In the above, the problems are divided into problem groups having two or more degree of difficulty and each of the groups includes one or more problems. Also, each problem has a problem explanation file describing and explaining itself. The problem explanation file is connected to a related problem. Further, these “conceptual contents and problems, and problem explanation files” (hereinafter referred to as “learning contents”, and one of them is referred to as “learning content”) have the header data related to each learning content, if needed. The header data may be connected to a portion that describes or explains the header data of the learning dictionary database or the conceptual contents.

FIG. 5 shows a packet structure of a problem data. Each of the problem file data preferably includes a header wherein a classification code, a grade code, a medium classification code such as a subject code, etc., a code divided by the minimum unit, a problem-native code, the degree of difficulty code and a learning time code are allocated with given bits, as shown in FIG. 3. Therefore, this classification can be variously changed depending on the necessity. At this time, it is preferred that allocation of the bit is determined using the number of the bits having a sufficient great number by the number of each item, like the mentioned conceptual contents data. If the problem data stored in the learning database are accessed by the learning progress server 7, a corresponding problem file data for the packet of FIG. 5 can be accessed using the header data. Further, each of the problem data may have a number of packet bytes following the header so that the problem data having a given size can be efficiently stored and managed. The number of the packet byte may have a fixed number, if necessary, thus, limiting the maximum size of the problem data.

FIG. 6-a shows a packet structure of a problem explanation data. Each of the problem explanation data preferably includes a header wherein a classification code, a grade code, a medium classification code such as a subject code, etc., a code divided by the minimum unit, a problem-native code, the degree of difficulty code and a learning time code are allocated with given bits, as shown in FIG. 3. Therefore, this classification can be variously changed depending on the necessity. At this time, it is preferred that allocation of the bits is determined using the number of the bits having a sufficient great number by the number of each item, like the mentioned conceptual content data. If the problem data stored in the learning database are accessed by the learning progress server 7, a corresponding problem explanation data for the packet of FIG. 5 can be accessed using the header data. Further, each of the problem data may have the number of allocated packet bytes following the header so that the problem explanation data having a given size can be efficiently stored and managed. The number of the packet bytes may have a fixed number, if necessary, thus limiting the maximum size of the problem explanation data.

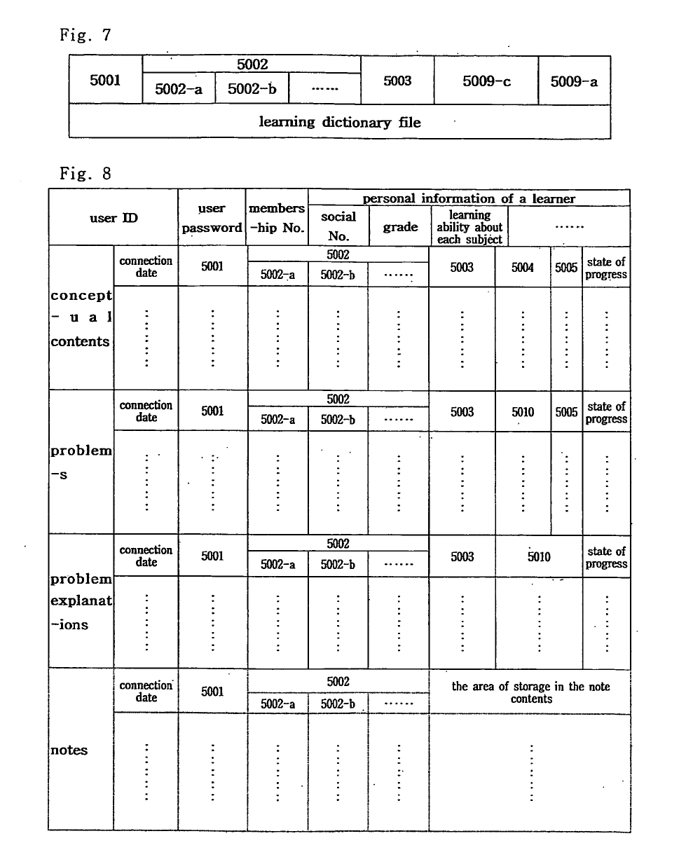

FIG. 7 shows a packet structure of a learning dictionary file. Each of the learning dictionary file preferably includes a header wherein a classification code, a grade code, a medium classification code such as a subject code, etc., a code divided by the minimum unit and a dictionary term code are allocated with given bits, as shown in FIG. 3. Therefore, this classification can be variously changed depending on the necessity. At this time, it is preferred that allocation of the bit is determined using the number of the bits having a sufficient great number by the number of each item, like the mentioned conceptual content data. If the learning dictionary file stored in the learning database is accessed by the learning progress server 7, a corresponding learning dictionary file for the packet of FIG. 5 may be accessed using the header data. Further, each of the learning dictionary files may have the number of packet bytes following the header so that the learning dictionary files having a given size can be efficiently stored and managed. The number of the packet bytes may have a fixed number, if necessary, thus limiting the maximum size of the learning dictionary file.

A third characteristic is that each learning content is produced so that it can be freely reconfigured/grouped according to its purpose, through a program and means for implementing a learning progress method that will be described in the detailed description, by allowing each learning content to have the above-mentioned packet structure. The reason why this function is especially important in the present invention is that a number of the learning contents are always collected and sequentially implemented in order for a learner to study for a given period of time since the learning contents are very finely classified. For this characteristic, the present invention is intended to provide the learning contents suitable for a learner's learning ability and conditions.

Manufacturing of this type of the learning contents is a new concept that does not exist in the prior art. For example, the existing conceptual contents that lecture or explain the curriculum contents are provided to the learner in the form of one or several files containing long time lecture content. This method does not suggest a concept that learning content is freely reconfigured in suit with each learner's learning ability or conditions. Therefore, in the conventional learning method, it is impossible to implement a method of allowing a learner to do custom-made learning through the Internet as if a private teacher for a specific lesson personally teaches the leaner.

Therefore, even in the case of the problem or the problem explanation file, as the prior art does not have the concept of the conceptual contents unlike the present invention, it is not classified for the minimum unit concept as in the present invention. Accordingly, the prior art does not suggest the concept that learning contents are variously reconfigured in line with each learner's learning ability or conditions.

2) Meaning of Minimum Unit

In order to understand the conceptual contents of the minimum unit, it is necessary to understand why this concept is generated. This is directly connected to the purpose of the present invention. A systematic foundation of the present invention for progressing the learning in suit with a learner's ability and conditions is based on databased learning contents. In order to understand the method of databasing the learning contents, it is inevitable to understand the conceptual content of the minimum unit. In other words, the more subdivided the range of the learning when the conceptual contents are produced, the more possible the custom-made learning for a more exact leaner. On the contrary, the lower the degree of subdivision, the more difficult a fine custom-made learning for the leaner. The concept that the individual learning contents must be produced with the minimum unit, allows a system that can find the need of a learner to study, and portions that the learning is needed and portions that the learning is not required (i.e., portions that the learner does not know or is lack or portions that the learner knows) as the size of the produced individual educational contents is small. The concept also allows a learning system that provides necessary learning contents to the learner to be constructed. Therefore, the conceptual contents that are produced with the minimum unit means that custom-made education is made fine for the leaner. The present invention has its main technical idea that learning contents can be divided into small units by maximum and the learning contents containing the divided conceptual contents files can be freely reconfigured, in order to improve efficiency of custom-made education.

The concept for the minimum unit may be different depending on a person. In particular, if desired targets are different even if they are the same person, their concepts may be different. Also, in some cases, two or more unit concepts can be produced into one file inevitably due to its mutual close correlation, etc. If the conceptual contents are produced having the mentioned technical idea, it can be considered as the conceptual contents of the minimum unit that the present invention pursues.

Of course, it is preferred that such learning contents are provided in the form of a file that provides a screen that can be viewed visually along with explanation sound except for the problem database 8-2. In particular, this need is more required for the conceptual contents and the problem explanation data. At this time, the screen that can be viewed visually may include documents written by various document writing means, etc. such as PowerPoint, etc. as well as the motion pictures. However, it is to be understood that such learning contents may include an audio form only or a text form only if it is classified by the minimum unit, and reconfiguration and combination can be flexibly made depending on the necessity for the learning process.

In order to explain the mentioned contents in more detail, the contents of each of the databases will now be explained.

(3) Conceptual Contents and Conceptual Contents Database 8-1

What the mentioned conceptual contents are databased is the conceptual contents database 8-1.

This will be described in more detail.

Each conceptual content can be produced into several files having different degrees of difficulty, as shown in FIG. 3 and FIGS. 4-a and 4-b. In this case, in order to clarify that the degree of difficulty of the conceptual contents is divided and produced, an example will be taken. From FIG. 3, for example, the concepts of the minimum unit are portions indicated as 4. 1. 1, 4. 1. 2, . . . . Three-step conceptual contents; “degree of difficulty 3” that contains only core contents every conceptual content and “degree of difficulty 2” for common learners, and the degree of difficulty 1 for beginners or persons who are lack of the learning ability can be produced.

As described above, the reason why the degree of difficulty is divided to manufacture the conceptual contents is to provide the conceptual contents of the most adequate form to the learner, considering the degree of understanding corresponding contents, the ability to learn knowledge, etc. The most important object to divide the degree of difficulty is time. The three conceptual contents whose degrees of difficulty are divided to be differ in time taken to implement each file. In case of the degree of difficulty 1, the degree of difficulty 2 may be produced shorter than the degree of difficulty 3. In case of learning the same range, short time is taken in the degree of difficulty 1 but mush more time is taken in the degree of difficulty 3. However, the learning contents can be easier understood compared to the learning using the degree of difficulty 3.

Therefore, databasing such conceptual contents according to divided degrees of difficulty can give significant high learning efficiency to the leaner. For example, in case of a learner who learns a study range that he or she does not know or a learner whose understanding ability is a little low, learning using the conceptual contents having the degree of difficulty 1 may be effective although more time is taken. If a student of over a middle class prepares a term-end examination for the range that the student already studied, it will be sufficient if the student basically uses the conceptual contents having the degree of difficulty 3 with respect to unknown portions and additionally uses the conceptual contents having the degrees of difficulty 1, 2, if necessary.

In particular, division of the degree of difficulty of such conceptual contents is useful in preparing the test of the elementary, middle and high school students. This is because the students usually must prepare various tests of various forms, have lots of repeated learning and are in different situations. The database of the present invention enables detailed custom-made learning since respective learning contents are produced so that they can be freely reconfigured and combined.

This will be described in more detail by way of example.

### EXAMPLE 1

Assumption

It is assumed that a second-year student of a middle school who has been using the learning system of the present invention for several years prepares a tern-end mathematical test. As a result of reviewing a learning history of a learning information database related to this student, it was found that regarding the contents listed in the education system of the present invention, the student had solved all the four problems, hit “rational number” problems, and answers wrong in one of “finite decimal” problems, two of “infinite decimal” problems and three of “recurring decimal” problems.

Learning Method

In this case, if the database of the conceptual contents is employed, by default,

the conceptual content related to a rational number are omitted, and

a finite decimal,

an infinite decimal and

a recurring decimal may be provided to the student by using the conceptual contents having the degree of difficulty 3 as a first learning tack.

It is to be understood that this is only one example. Provision of these custom-made learning materials can be applied to all learning. This is described more deeply while being correlated to the problem database 8-2 that will be described in the latter part. Therefore, even if there are enormous numbers of learners, the property that the learning materials are reconfigured and assembled suitably for each learner is a new and important characteristic component of the present invention.

In the conceptual contents, however, although the minimum unit can be indispensable, the multi-step configuration depending on the degree of difficulty is not indispensable. Depending on learning contents or a learning method, the conceptual contents database 8-1 can be produced without considering the degree of difficulty.

A selective component of a single conceptual content is to select the header data, so that it can be used upon learning. The header data may be previously connected to a dictionary related to a corresponding lesson by means of a hypertext function, or connected to the conceptual content related to the header data.

(4) Problem Database 8-2 and Problem Explanation File Database 8-3

The most important characteristic of the problem database 8-2 can be classified mainly into three elements.

First, it is preferred that the problem database is paired with the problem explanation file explaining its problem for each problem file. Of course, each of the problems is connected to corresponding conceptual contents so that the conceptual contents may serve as the problem explanation file. If additional problem explanation file is not required since it is so clear, the problem explanation file is not required. This problem file or the problem explanation file may be accompanied by a screen produced by a video camera, PowerPoint, etc., or may be variously produced in a text format, and may be accompanied or not by sound. This can be more clearly defined through the packet structure of the problem file data shown in FIG. 5 and the packet structure of the problem explanation data shown in FIG. 6. The packet of each of the problem file data and the problem explanation data includes a header wherein a classification code, a grade code, a subject code, a medium classification code, a code divided by the minimum unit, a problem-native code and a difficulty degree code are allocated with given bits. As this has a common header structure in the problem file data and the problem explanation data, the learning progress server 7 can make the problem database 8-2 and the problem explanation file database 8-3 paired using the header data for the learning data server 8. Further, each of the problem data packet and the problem explanation data packet has a structure in which a given number of packet bytes following the header are allocated. Thus, the data packet has an advantage that it can be written and managed in various forms of information since it is not restricted to the type or size of the data.

A second characteristic of the problem database is that the paired problem data and problem explanation data are not only divided/classified for the conceptual contents of the minimum unit, as described above, but also since there are lots of problems related to a single conceptual content, they are divided into several groups of the problems divided in multi-steps for the degree of difficulty. As problems related to the important conceptual content are divided into more many degrees of difficulty, more many groups of the problems may exist. As problems related to the conceptual content whose importance is low are small in their problem numbers, division of the degree of difficulty and the number of the problems may be small. In some case, there will be a case where one problem is related to one or more conceptual contents, thus making difficult to classify the problems exactly. In this case, however, if those problems are classified in the closest conceptual content and related facts are marked in other related conceptual contents, or problems files are databased according to the principle that the same problem files are located in all the related conceptual contents and the problem files are produced when a program utilizing or operating the database is produce, problems occurring from this can be solved.

In the problem database, the step of the degree of difficulty in a problem must be two or more steps. However, a more preferred step is 3 to 10 steps. The greater the number of the problem for each step, the better it will be. However, if the number of the problems belonging to it as the conceptual content of high importance is too great, it would be better to control the number of the questions for each step by extending the step of the degree of difficulty.

To what degree the step of the degree of difficulty for conceptual contents and the number of problems belonging to each step must match, may be flexibly decided considering various factors including a characteristic of a corresponding subject, the difference in the importance between the conceptual contents, etc. It is preferred that each of the conceptual contents has a similar number of the degree of difficulty step and each step has a similar group of problems.

A third characteristic is that respective files must be produced so that they can be divided separately and can be thus freely reconfigured and assembled, as in the conceptual contents. This is possible if the data are made to have the packet structure in FIG. 5 and FIG. 6.

In the problem database, two or more problems may be contained within one problem file depending on a case. This may be applied to a case where the number of problems for each classification is too many or a case where repeated education is important, like a mathematic subject of an elementary school student. In the mathematic subject of the elementary school, repeated education is important and similar problems can be easily made.

This will be more clearly understood with reference to FIG. 3 to FIG. 7.

(5) Explanation of Learning Contents Database Method Through FIG. 3

FIG. 3 is a table showing how the learning contents related to creation of composition belonging to a fourth unit of Korean language learning range of second-year in a first semester of the middle school is databased. The learning range referred to as “4. Creation of composition, 5. Background of Novel . . . ” belongs to a large classification, the learning range referred to as “A. Guidepost of Unit, B. Predicate of Sentence . . . ” belongs to a medium classification, and “Structure of Composition, Basic Frame of Composition . . . ” described below belong to the conceptual contents sub-divided by the minimum unit.

Such division may be different depending on a person. As described above, however, if the conceptual contents that are finely sub-divided are produced by sub-dividing portions that a learner does not know and portions that the learner knows, time taken for the learner to study the portions that the learner knows can be minimized and the learner can repeatedly study the portions that the learner does not know until the learner completely understand those portions from various viewpoints. It is thus possible to significantly improve learning efficiency. As a result, although the division or expression of respective conceptual contents can be different depending on a person, it may be considered that the conceptual contents have the learning contents concept same to the present invention if such concept was already implemented.

Further, respective conceptual contents may be produced in various shapes, as shown in FIG. 3. In general, as shown in FIG. 3, the conceptual contents may be produced by dividing them into three shapes: \textcircled{1} file explaining simply and clearly only the core of the concept (degree of difficulty 3), \textcircled{2} file explaining the concept relatively in detail (degree of difficulty 2), \textcircled{3} file explaining the concept in detail by maximum by taking an example (degree of difficulty 1). Of course, such conceptual contents may have different shapes and numbers depending on the conditions as well as the three shapes shown in FIG. 3. Further, this is for the purpose of constructing finely and providing the learning contents that are best suitable for the learning conditions of a learner.

Next, the problems and the problem explanation database will be described.

As shown in FIG. 3, there are six problem groups divided into six degrees of difficulty for detailed conceptual content, and the problem database 8-2 and the problem explanation file database 8-3 having about 10 problems and problem explanations. It is preferred that the step of the degree of difficulty for respective contents and the number of the problems including each degree of difficulty are matched similarly but may be different depending on the situation. Further, it will be preferred that the step number of the degree of difficulty is matched every conceptual content as possible but important conceptual contents and unimportant portions may be different depending on a case. This can be freely selected depending on whether the degree of difficulty code is included in the header when the packet in FIG. 4 is accessed.

In addition, each of the problems has the problem explanation file in principle, as shown in FIG. 3. The function of the problem explanation file can be replaced with the conceptual contents.

A selective component of another problem explanation file enables the header data of the learning contents to be used when extracting and learning the header data. These header data may be connected to a dictionary related to a corresponding subject by a link function and may be connected to an individual conceptual content related to their header data. The characteristics in this process are made possible by accessing all the data using each header data in the form of the packet. In the above, the header data may be selectively selected in order to diversify the access.

In FIG. 3, “A” is the number of the problems for a corresponding conceptual content of the problem database and “B” is the number of the problem explanation file connected to each problem. “a” is a conceptual content to describe simply the concept of the core contents for a learner having a high level of a learning ability with respect to the classification divided by the minimum unit on the left side, “b” is a conceptual content that is made on the basis of a common learner level with respect to the classification divided by the minimum unit on the left side, and “c” is a conceptual content to describe in detail the concept of the core contents for a learner having a low level of a learning ability with respect to the classification divided by the minimum unit on the left side.

3. Learning Information Database 6-2 and Learning Information Management Program 6-1

(1) Learning Information Database 6-2

The Internet learning system of the present invention has the learning information database 6-2 in which personal learning-related items for each learner are databased as one element, The learning information database 6-2 is a collection of “storage spaces wherein learned-related information divided for each learner, including learning history of the learner, items related to the learning ability, and items related to personal information, is databased”.

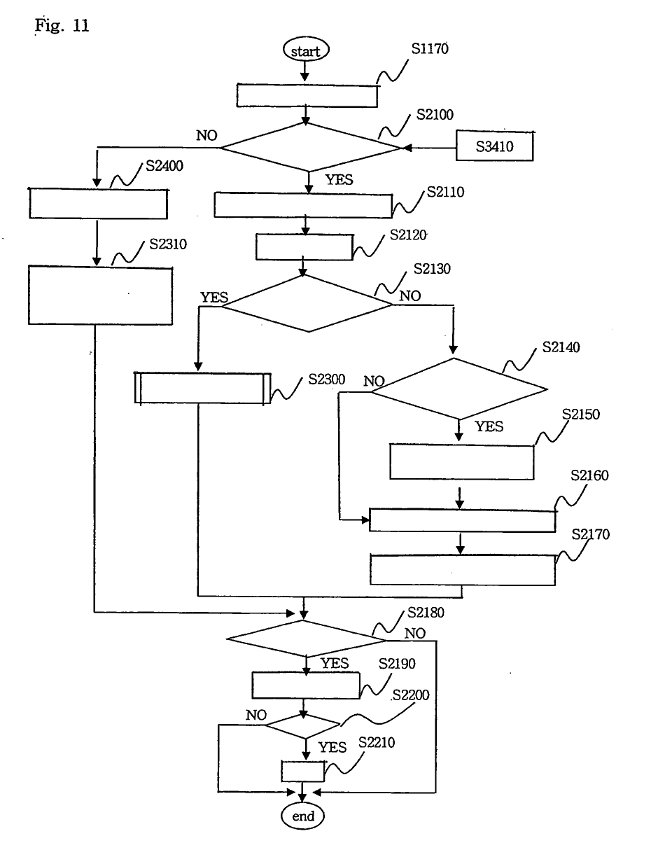

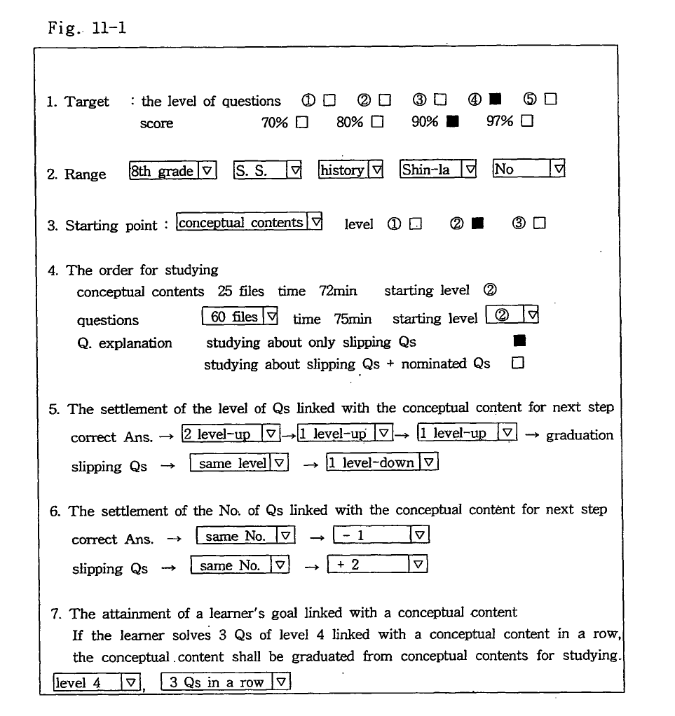

The learning information database 6-2 will now be described in detail with reference to FIG. 8 and FIG. 11 with reference to the contents of information contained in a learning information dept for each person.

\textcircled{1} Learned History Information

The most important information in the present database is a learned history of each learner, which will be explained in more detail later. A learning process in the Internet learning system is as follow:

It was determined that the learner does not know as a result of reviewing the result that the learner learned. In this case, explain in detail easily what the learner does not know, and have the learner understood by letting the learner to solve many related problems,

It was determined that the learner knows as a result of reviewing the result that the learner learned. In this case, let the learner to solve problems having a higher degree of difficulty so that the learner reaches a target level,

Exclude portions that the learner reached a target level. This saves time and allows the learner to understand the learning range within a short period of time as possible.

For this, a means for recognizing the history that the learner learned in the past, which are related to a corresponding learning content when the learner studies next time, is required. Learning is repeatedly performed through the means, considering the learning history of the learner in the above manner.

Therefore, the past learning history of the learner must include:

Information related to a state where the learner studied for a conceptual content of the minimum unit (FIG. 8)

\textcircled{2} Items Related to Learning Ability of a Learner

The learning ability of the learner and related items are not necessarily required. This is because the learning ability of the learner is automatically considered through the learned history as the learner continues to study. However the result of measuring the learning ability through a given test, etc. when the study initially starts may be reflected to the study.

\textcircled{3} Items Related to Personal Information of a Learner

If the learner is a student, necessary information related to study may be arbitrarily set. It is usually written when the learner becomes a member.

\textcircled{4} Explanation Through FIG. 8 and FIG. 11

FIG. 8 shows one embodiment of a learning information packet of a learner. A first row includes information related to personal information of the learner allocated with given bits. Below are located conceptual contents, problems, and several sections for storing the learning history related to the problem explanation file. A code that divides respective data can be suitably set depending on the learning contents. Further, the learner may want to write down something during learning. In this case, it is preferred that there is formed a space (FIG. 8) for storing desired contents that the learner wants to write during the learning using the learning note management program 6-4.

(2) Learning Information Management Program 6-1

As described above, the most important information of learning information relates to the learned history. Such a learned history results from the learning procedure and its result. The learning information management program serves to store necessary learning information in the learning information database 6-2 based on the learned procedure and its result of the learner and transfer the stored learning information to the learning plan configuration program 7-1.

The learning plan configuration program 7-1 performs processes shown in FIG. 11 to FIG. 17. The learning information management program 6-1 can be integrated with the learning plan configuration program 7-1.

4. Learning Plan Configuration Program 7-1

The learning plan configuration program 7-1 controls the conceptual contents configuration program 7-2, the problem configuration program 7-3, the test scoring program 7-4 and the problem explanation file configuration program 7-5 to sequentially operate according to a progress sequence of a learning procedure table (shown in FIG. 11-1) set in a learning procedure-setting step (S2000) in FIG. 11. The learning, however, does not always proceed sequentially as described above. The learning can be modified (S2210) and assembled variously, depending on the conditions of a previous learning history and a learner by means of selection of the learner. Any one of the conceptual contents configuration program 7-2, the problem configuration program 7-3, the test scoring program 7-4 and the problem explanation file configuration program 7-5 starts according to the learning progress sequence and contents that are transferred from the learning information management program 6-1 when an initial learning begins. If the program starts, however, a learning content of a next step is decided according to the learning result for each step and its general progress is governed by the learning plan configuration program 7-1. At this time, information is received through the learning information management program 6-1, if necessary.

The proposed learning content may be modified by selection of the leaner.

If the learner uses the system of the present invention for the first time, a standard type learning content may be designed (S2300, S3430). Also the learning content may be decided considering the learning ability of the learner. If the learning content is set to be modified by the learner, however, the leaner may modify the Teaming content suitably for him or her (S2140 to S2170, S3450, S3470).

This will be clearly understood by explaining it by way of example.

### EXAMPLE 2

### Exemplary Procedure of Learning Plan Configuration

If a learner sets a learning range and a target,

In step 1, a learning procedure of the conceptual contents considering the learning ability of the learner is provided (at this time, learning time may be decided by the conceptual contents that are selected by the learning range and the learning ability)

In step 2, groups of related adequate problems are provided: In a first test, it is a principle that one or more problems are set for all the conceptual contents within the Teaming range (In case of an important conceptual content, two or more problems may be set), in order to increase the completeness of the studying (learning time can be calculated).

In step 3, explanation on the wrong problems is provided. If necessary or according to selection of a learner, related conceptual contents learning materials are provided.

In step 4, groups of custom-made problems are provided to the learner. (although various methods may be adopted, it is preferred that an increased number of problems with similar degrees of difficulty are set regarding the wrong problems, and a reduced number of problems with an increased degree of difficulty are set regarding the wrong problems, wherein this can be automatically set and can be arbitrarily controlled by the learner.)

A target level can be reached by repeating the steps 3 and 4.

According to the learning method described in the above example, an adequate learning method can be planned considering time when the learner can study since implementation time for each learning file is set in all the learning databases and it is not difficult to arbitrarily set adequate time taken to solve the problem.

At this time, after the learning range of the learner and learning-related conditions are specified, an adequate learning method may be changed depending on “a case that learning time is important”, “a case that a learning achievement level is important”, and “a case that a target is set by adequately mixing the learning time and the learning achievement level”.

Another example will be taken.

### EXAMPLE

### Exemplary Procedure of Learning Plan Configuration

In case that a learner learns the content learned in the part

For example, if time elapsed after learning in the past is within one month, it may be set that the learner immediately enters a third step of (example 2) based on the learning in the past without learning the conceptual contents and applies the sequential learning method.

If time elapsed after the learning in the past is one to three months, it may be set that the learner first learns only detailed conceptual contents related to wrong problems and then returns to the third step of (example 2).

If time elapsed after the learning in the past exceeds three months, it may be set that the learner learns simple conceptual contents in the event of hit problems and learns detailed conceptual contents in case of wrong problems and then returns to the third step of (example 2).

The term or application mode described in the example is only illustrative in order to explain its mode and in an actual situation, can be variously set considering the characteristics of the learning content, the learning ability of a learner, etc. (FIG. 11, S2210)

5. Learning Progress Step (S3000)

The learning progress method in the present invention will now be described in detail by way of example.

The present example does not include the process of allowing a learner to access the system through the Internet and the process of authenticating the learner The reason why the present example does not include the two processes is that the system is so manufactured that the learner can stop learning at any step to log out the system and access at any time to continue the learning. Further, this type of the access and authentication method is not an inventive step of the present invention but is well known in the art.

(1) Learner Conditions: A Learner Who Accesses the System and Gets Authenticated and the Contents that the Learner will Learn, are Assumed as Follows:

\textcircled{1} Learner's Name: Cheol-So
Grade: second year of middle school

\textcircled{2} Learning range: “Creation of Composition” at a fourth unit of Korean language, a first term of second year of middle school

\textcircled{3} The learner uses the system for the first time.
The learner had no experience in learning regarding the learning range in the past.

\textcircled{4} Learning's target: understand up to 80% of problems having the highest degree of difficulty

\textcircled{5} Possible learning term: no limit (continue to study until the target is reached)

(2) Progress in Learning Information Management Server System 6 and Learning Progress Server System 7

\textcircled{1} Learning Information Management Program 6-1

i) Search information on a learner through the learning information database 6-2

Search result: within 20% in the score of a Korean language at a school

ii) Calculate the learner's learning ability through the learner learning ability measurement program 6-3

The learner's measurement of the learning ability through I.Q. test, etc.

Measured result: assuming that the thinking faculty is the highest and the memory is excellent

iii) Calculate a learning progress sequence and contents considering the learner's learning ability

iv) The calculated learning progress sequence and contents are transmitted to the learning plan configuration program 7-1

In the above, the learning progress sequence and contents can be confirmed by the learner (including person who helps the learning)

\textcircled{2} Learning Plan Configuration Program 7-1

i) The learning plan configuration program 7-1 uses the learning progress sequence and contents received from the learning information management program 6-1 to control the conceptual-contents configuration program 7-2, the problem configuration program 7-3, the test scoring program 7-4 and the problem explanation file configuration program 7-5 so that they can sequentially operate, according to the sequence.

ii) At the request of a learner, etc., the learning plan configuration program 7-1 can provide an “adequate learning plan”.

If the learner inputs possible learning time and a learning range, an adequate learning plan is configured considering parameters including the possible learning time, the learning range, the past learning history, the learning ability, the learning target, etc. and is then provided to the learner.

In the above, the adequate learning plan for accomplishing the target and an estimated time taken to do the learning can be calculated and are then provided, if necessary.

In case of Cheol-So, since all the components through which the adequate learning plan can be written in (1-1) are written, the adequate learning plan can be written by the program.

(Example of Adequate Learning Plan)

Target of Learning: To understand up to 80% of problems having
the highest degree of difficulty
This target can be represented in various forms by calculating
correlation with a school test, an educational test, etc.
Expected time taken: 13.5 to 16.5 hours
Learning Progress Step

| | |
|---|---|
| 1 step | (2.5 hours): Learn groups of the conceptual contents |
| | constructed by the conceptual contents selection |
| | program 7-2 |
| | (2 hours): Test and score the problem groups |
| | constructed by the problem selection program 7-3 |
| | (total number: 100 problems) |
| | (2 to 3 hours): Review wrong problems by the problem |
| | explanation file groups constructed by the problem |
| | explanation file selection program 7-5 |
| 2 step | (2 hours): Test and score the problem groups |
| | reconstructed by the problem selection program |
| | (total number: 100 problems) |
| | (2 to 3 hours): Review wrong problems by the problem |
| | explanation file groups constructed by the problem |
| | explanation file selection program |
| 3 step | (2 hours): Test and score the problem groups |
| | reconstructed by the problem selection program |
| | (total number: 100 problems) |
| | (1 to 2 hours): Review wrong problems by groups of |
| | the problem explanation files constructed by the problem |
| | explanation file selection program |

\textcircled{3} Conceptual contents configuration program 7-2

i) Considering the components of a learner's learning ability and the property of a learning range in connection with the learning plan configuration program 7-1, the conceptual contents to be learned through the conceptual contents database 8-1 are constructed.

If a necessary learning ability is scored in order for a beginner to normally understand when the conceptual content is produced, it will help to form the conceptual content that must be automatically learned by the learner since it meets the learning ability of the learner among the conceptual content within the learning range to be learned.

ii) As an optional factor, if there are things related to the conceptual content for the conceptual contents of a given time interval or a given number, various contents (nurse, good phrases, scenery pictures, good moving pictures, quiz, etc.) that will make the learner delightful or increase a learning desire can be inserted between the conceptual contents.

iii) In case of Cheol-So, since he is relatively high in a school grade and has a good thinking faculty, the conceptual content having a medium degree of difficulty may be constructed even if he is a beginner.

If it is a step that the learner constructs only conceptual contents related to wrong problems after solving the problem, the conceptual contents having a low degree of difficulty in which detailed explanation on the learning contents is given may be constructed.

Step of allowing the learner to study a group of the conceptual contents provided to the learner

i) Capable of providing a means that will assist various learning as an optional element

Extracted header data of individual conceptual content may be connected to a dictionary related to a corresponding subject by a hypertext function or to an individual conceptual content related to its header data.

These header data can solve any questions with several operations for the contents that the learner does not understand since the header data are displayed at a given portion of the screen where the learning window is displayed.

ii) Capable of providing a learning note means as an optional element

It is preferred that the learning note is a note wherein the contents are previously arranged in the dictionary for a conceptual content and can be modified by the learner, if necessary. Depending on a case, however, only a space and means that can be produced by the learner if needed may be provided.

Further, this note may be automatically or selectively stored at the learner's learning information depot.

\textcircled{5} Program for selecting and automatically constructing problems considering the degree of difficulty in conjunction with the learning history for a corresponding learning range of the learner, components of the learning ability and the property of the learning range (problem configuration program 7-3).

If there is the past learning history for the corresponding learning range of the learner, it is preferentially considered and an adequate group of problems to the learner can be constructed. However, in case of Cheol-So, he is new in this learning range. Thus Cheol-So's learning ability is preferentially considered.

If a learner usually studies for the first time, a test with problems of a first step or a second step of the problem database in FIG. 1 must be given. However, in case of Cheol-So, as a Korean language grade relatively ranks high and has a superior thinking faculty at the school, a test of a 3 step may start initially.

Another important factor is to decide problems to be set for a text.

Each conceptual content is classified, scored or graded depending on the importance of the learning and is then assigned with a score or a grade. These parameters are then used to set the problems.

In principle, the number of the set problems is at least one for a conceptual content within the learning range and the number of the problem in an important section is increased.

If the number of the problems is too many, the problems having a low importance may be omitted or may be set along with problems having a high degree of difficulty after a given step.

It is preferred that this selection is not manually carried out by a person but is automatically constructed by “the problem selection program 7-3” on the basis of the learning ability that is automatically calculated by “the learner learning ability measurement program 6-3”.

However, the construction of this group of the problems provided thus can provide a learner, a learning helper, parents, etc. with an authority to modify the problems.

Optionally, if there are given time interval, a given number of problems or things related to the problems depending on a case, various contents (nurse, good phrases, scenery pictures, good moving pictures, quiz, etc.) that will make the learner delightful or increase a learning desire can be inserted between the conceptual contents.

\textcircled{6} Learner's test: Though various test modes may be selectively performed, a specific one mode is provided by default in principle.

\textcircled{7} Test scoring program 7-4: Scoring test implemented by the learner

Modes for scoring the test are well known in the market. Any one of them may be selectively employed.

\textcircled{8} Review learning centering on wrong problems as a result of the scoring

i) The problem explanation files connected to the wrong problems are constructed and are then provided as learning materials (problem explanation file configuration program 7-5)

ii) In case where the conceptual contents are needed to be provided or the problem explanation files are not equipped, related conceptual contents may be constructed and provided.

The problem explanation files and the conceptual contents are automatically constructed and provided, and the construction of the provided contents may be modified by the learner, the helper, etc.

iii) Means for assisting various learning can be provided as an optional element.

In each problem explanation file and conceptual content, the header data that becomes the center in the learning contents can be extracted and then connected to a dictionary related to a corresponding subject by the hyper function, or connected to each conceptual content related to its header data.

These header data can solve questions through several operations for the contents not understood by the learner since it is displayed in a given portion of the screen in which a learning window is displayed.

iv) Capable of providing a learning note means as an optional element

It is preferable that the learning note is a note in which the contents are previously arranged for a conceptual content related to wrong problems and can be modified by the learner, if needed. Depending on a case, however, only a space and means in which the learner can produce the node, if necessary, can be provided.

Further, this node may be made to be automatically or selectively stored at the learning note management program 6-4.

Progress of Second-Step Learning

\textcircled{1} Problems to be Tested Again are Selected/Configured Considering Degree of Difficulty Taking Test Result of Learner Into Consideration, (Problem Configuration Program 7-3)

i) Principle to select problems for a test to be performed again in the present invention when learning continues after a just-before test (example)

Problems hit in the just-before test
It is a principle to set problems whose degree of difficulty is increased.
The number of the problems to be set is gradually reduced. If a learner reaches a target learning level by hitting the problems of the final degree of difficulty that are selected by the learner, etc. through repeated review, the hit problems are excluded from the subjects to be learned.

If the learner answers the problems wrong in the just-before test.
Learning through related problem explanation files and conceptual contents, if necessary
Such problem set modes may be selected such as a mode to set again problems whose degree of difficulty is similar or a little low or a mode to set again problems whose degree of difficulty is a little high.
The number of the set problems is gradually increased in order to provide a change that the learner can repeat the learning on unknown problems.

ii) Principle to select problems that need to be tested again in the present invention since substantial time elapsed after the just-before test (example)

If the learning is not carried out for a substantial period of time although it was already learned, there is a high possibility that a learner might have forgotten lots of portions. Thus a preliminary learning process before entering the (1-3-1-1) step may be needed.

This preliminary learning may be changed depending on the length of a period where the learner does not study, the learner's ability and the score of the learning range. The learning plan configuration program 7-1 can be produced so that one of several types listed below is set as the preliminary learning process considering the above three facts and is then provided to the learner.
Provide groups of related conceptual contents within the learning range as the learning range: In this case, it can be applied to a case that there is a special reason such as the learning is stopped for a long time. Even in this case, the degree of difficulty of the conceptual contents may be decided depending on the degree.
Provide groups of the conceptual contents related to the wrong problems in the just before test It may be reflected when the program is written where the learning regarding the learning range for one month to six months as learning materials of a common level is stopped.

As a result, the contents of the learning process that starts again since a long time elapsed after the just-before learning mentioned above, may be decided by factors including “length of a period where the learning is not performed” or “learner's ability”, “character of the learning range”.
The program will be written in such a manner that more many preliminary learning processes are provided as the period where the learner did not learn is longer, the ability of the learner is lower and the content of the learning range is more difficult.

\textcircled{2} Learner's Test on Reconfigured Problem Groups, Scoring and Review of Studies on Wrong Problems

Proceeds in the mode such as \textcircled{5}, \textcircled{6} and \textcircled{7}) of (2)

(4) Third Step, Fourth Step . . . Learning: Learning is repeatedly performed in the mode such as (1-3)

As the degree of difficulty for each problem is decided in a group of problems groups assigned to a learner every step, the degree of the ability for a corresponding range of the learner could be instantly evaluated and confirmed.

Therefore, the learner, etc. can progress the learning according to its target.

(5) Completion of Learning

Completion of the learning can be variously operated depending on the conditions, intention, etc. of a learner, for example, after a target level is reached, after a learning schedule is finished, etc.

However, it will be preferred that the learner finish the learning after reaching the learning target.

(6) Relationship with Learning Information Database 6-2

Learning information for a person can be stored at the learning information database 6-2 in various forms and modes. Learning information can be batch-processed finally and stored immediately when information every step is generated.

However, indispensable learning information for a person is accumulated and provided to a program of each step. The program is utilized for intended purpose. This is because the learning information management program 6-1 is operated between various programs for progressing the learning and the learning information database 6-2, as described above.

Components of the learning information database 6-2
Items related to learner's learning ability: (example) I.Q. (thinking faculty, memory, etc.), learning record on each learning range, etc.
Learner's learning history
   Learning contents of the conceptual contents: range, time, detailed contents of the learning
   Problem test learning contents: range, level of learned problems, result of correct wrong answers for each problem, problem explanation learning conditions, etc
      6. Explanation of Learning Progress Method Through <Example 6>

(1) Setting

Assumed that a learner who learned the learning contents of a given range using the existing system totally reviews learning that the learner did in the past such as a final review step of an educational text, a term-end test and a licensed real estate agency text.

(2) Learning method

\textcircled{1} When there is enough time

Learn related conceptual contents groups centering on wrong problems in the past

Then, retest problems by setting more problems having the degree of difficulty in a learning range similar to the wrong problems and reducing problems having a high degree of difficulty regarding the learning range of the hit problems.

After the retest, reconfigure and learn related problem explanation files of the wrong problems.

Through the above method, while the degree of difficulty is gradually increased, relearning is performed until unknown portions disappear.

\textcircled{2} When there is short of time

In \textcircled{1}, the step of learning the related conceptual contents is omitted and learning is similarly carried out from a next step.

7. Characteristics of Internet Educational System of Present Invention

The characteristics of the Internet learning system of the present invention will now be described centering on the above-mentioned detailed explanation and examples.

First, as all the contents are independently generated in connection with the minimum unit conceptual content, each learning content can be freely reconfigured. For this reason, the characteristics areas follows:

\textcircled{1} It is possible to divide a learner's known portions and unknown portions to an extent of a very fine concept.

\textcircled{2} It is thus possible to minimize time taken to learn the known portions.

\textcircled{3} As the learner can concentrate on the unknown portions, the learner can learn efficiently items that the learner has to learn.

Second, characteristics due to the correlation between the programs for a step, the learning information database 6-2, and the learning information management program 6-1

\textcircled{1} Learning materials in each learning step are constructed best suitably for the conditions of a learner and are then automatically provided to the learner by default.

It is therefore possible to minimize the learner's trouble in selecting or writing the learning conditions.

However, it is preferred that custom property and suitability of the learning contents are considered by providing a means for manual modification to the learner, etc. at the same time in most learning steps.

Third, characteristics by a learning-assistant means: the learning dictionary database 8-4 or the conceptual contents database 8-1 can be utilized as the learning-assistant means.

\textcircled{1} It is preferred that a learning means is provided which can immediately solve a learner's questions by stopping the window temporarily, when the learner has some questions due to unknown portions during learning.

The header data are extracted every conceptual content and problem explanation file so that their conceptual contents and the problem explanation files can be easily connected to related conceptual content or a corresponding page of a learning dictionary.

The conceptual contents are connected to these header data, thus serving as a term dictionary, and can be connected to additional learning dictionary.

Fourth, in the present invention, it is preferable that the conceptual contents and the problem explanation files are produced in the form having a visual screen (including moving pictures, screens written by a means such as PowerPoint, etc.) accompanied by sound explanation. Explaining in more detail, it is required that a learning content provided be constructed so that a learner can automatically study the learning only if the learner listens explanation while seeing the screen. Thus, the learner can easily study the learning for a long time. Even when the learner studies unknown portions through the header data, related conceptual contents serve as a dictionary, so that learner can easily learn the unknown portions.

FIG. 8 shows a learning data structure for a learner that is managed every learner.

If the learner accesses the system-operating server 3 through the learner terminal 1 over the Internet or Intranet, the learner is connected to the learning system through the connection section 4 and the authentication section 5. At this time, information on the conceptual contents, problem data, problem explanation files, note contents, etc., which were provided to the learner every time when the learner finishes the learning after every access, is stored. Information for confirming personal identity such as a user ID, a user password, a social card number and a membership no., information related to personal information, etc. are recorded at the forefront of the personal data, so that data per learner can be discriminated. Further, information such as the conceptual contents, the problem data, the problem explanation files, the note contents, etc. that had been provided to the learner, is extracted from a head portion of each packet, and access time and a progress state for a corresponding packet are recorded, so that they can be utilized in a next access. In the above, the progress state contains information on whether corresponding learning is performed, how its result is in case of the problem data, and the like. The learning data for the learner are personally kept in the learning information database 6-2 of the learning information management server 6 and is provided to the learner in a next access (S2400). Therefore, the learner can determine whether to repeat the previously learned contents or proceed to a next step of the previous learning contents. FIG. 8 shows an example in which the previously learned contents every database are stored one by one. However, the number of the data stored every person can be allocated arbitrarily depending on its necessity.

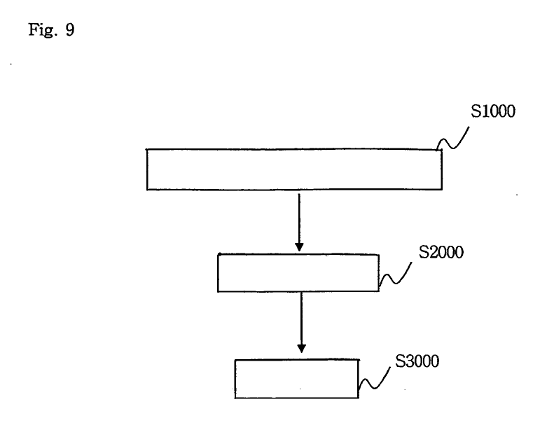

FIG. 9 is a flowchart illustrating process steps of the Internet learning system according to a preferred embodiment of the present invention.

Referring to FIG. 9, the Internet learning system of the present invention includes a member joining and initial learning ability input step (S1000), a learning procedure-setting step (S2000) and a learning progress step (S3000).

In the member joining and initial learning ability input step (S1000), a learner accesses a web server managed on the Internet through his or her terminal, gets authenticated, and get checked for personal information and a learning ability, if necessary.

In the learning procedure-setting step (S2000), the leaner sets the entire learning procedure by setting a learning subject, a learning range, a start step of the learning, conceptual contents to be learned, the degree of difficulty of problems, and the like (S2110 to S2170), for a new learning. Further, if necessary, the learner can write a learning procedure table (S2190, FIG. 11-1) indicating the entire learning procedure or modify the procedure depending on the learner's selection (S2210).

The learning progress step (S3000) is a process in which the learner actually studies according to the learning procedure table. The learning progress step (S3000) includes a step of learning the problem explanation file centering on the learning contents, a problem test and wrong problems and a step of reconstructing learning contents at a next step (S3400) and then repeating the learning.

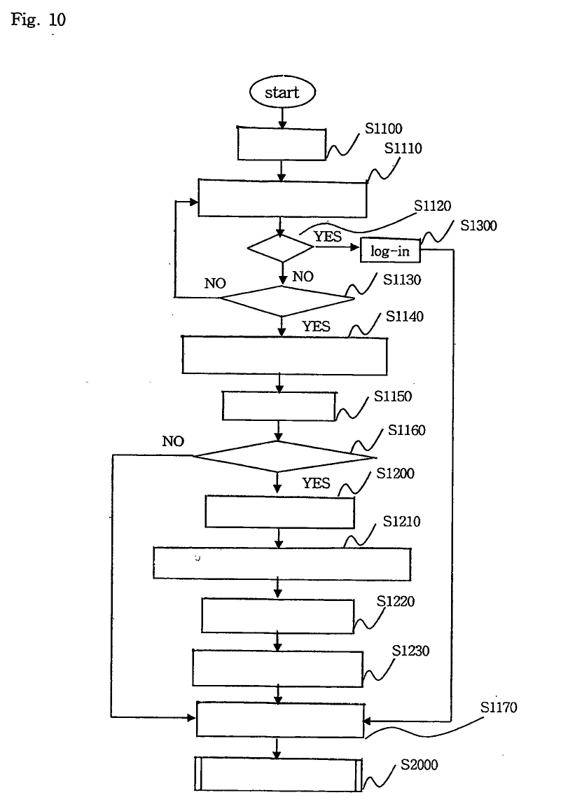

FIG. 10 is a flowchart illustrating a process of allowing a user to join a member and of allowing a new member to input his or her initial learning ability according to a preferred embodiment of the present invention.

Referring to FIG. 10, if a learner terminal successfully accesses a corresponding web server (S1100), the web server transmits an initial web page to the learner terminal (S1110). The web server determines whether the learner is a registered member (S1120). As a result of the determination, if it is determined that the learner is not a member, the web server confirms whether the learner wants to be a member (S1130). If it is determined that the learner wanted to be a member, the web server transmits a web page for a member joining to the learner terminal (S1140). The web server then receives personal information on a new member through the joining page (S1150). Further, the web server determines whether the new member wants to get the member's learning ability checked (S1160) If it is determined that the member wanted to get the member's learning ability checked, the web server allows the member to set desired fields (S2100), then transmits a group of ability test problems suitable for him or her the member (S1210), evaluates the learner's ability (S1220), stores the result in the member's learning information database formed after the member joined the membership (S1230), and then transmits a main page to the learner terminal in order to execute the following learning procedure (S1170).

FIG. 11 shows the step of setting the learning procedure according to a preferred embodiment of the present invention.

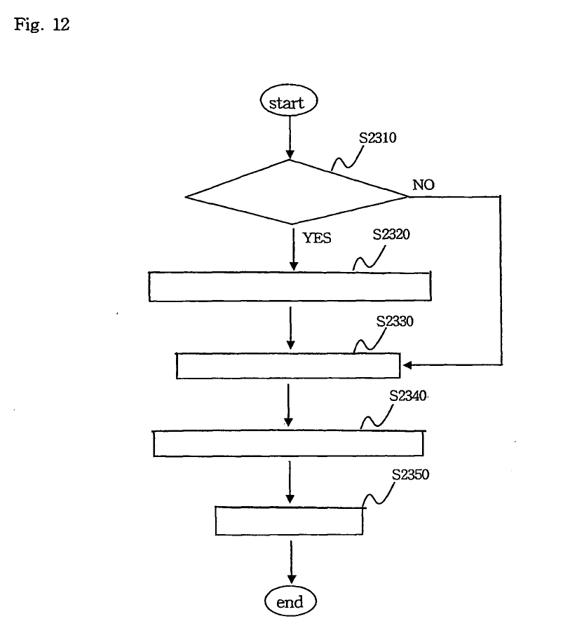

Referring to FIG: 11, if the main web page appears according to FIG; 10, it is determined whether the learner starts new learning (S2100). Such new learning can be selected at any time by the existing learner as well as a new member. In case where a learning target of a previous step is reached, a new learning must start (S3410). If it is determined that the learner selected to start the new learning, the learner, etc. sets a learning subject, a learning range and a learning target (S2110, S2120) and then determines whether the learning procedure is to be automatically set (S2130). If it is determined that the learner wanted that the learning procedure must be automatically set, the learning plan configuration program 7-1 sets the learning procedure based on the previously set contents (S2300). This will be described in detail with reference to FIG. 12. Meanwhile, if it is determined that the learner wanted that the learning procedure need not to be automatically set in step 2130, the learner manually sets learning conditions. The learner determines whether to start the learning from the conceptual contents (S2140). If so, the learner sets the conceptual contents to be learned and the degree of difficulty of the problems (S2150, S2160) and then sets the number of the problems to be learned per one times (S2170).

However, if the learner wanted to study the learning in connection with the contents learned in the past not the new learning in the main web page in step S2100, the past learning information is loaded (S2400). If the learner specifies contents to be learned from the contents learned in the past, he or she can study following the contents learned in the past (S2310).

Preferably, the set learning procedure can be written into the learning procedure table. This can be outputted on the screen depending on the learner selection (S2180, S2190). One example of the learning procedure table is illustrated in FIG. 11-1. Therefore, if the set learning procedure can be recognized considering its contents, it could be considered as the same technical spirit even if its form is different. Further, the learner, etc. can modify his or her learning procedure once again through the learning procedure table (S2200, S2210). This will be very useful in that the learning procedure can be variously configured depending on time elapsed where the learning is made following the contents learned in the past.

FIG. 12 is a flowchart illustrating the process of automatically setting the learning step according to a preferred embodiment of the present invention in the context of FIG. 11.

Referring to FIG. 12, it is first determined whether the learning is performed from the conceptual contents (S2310). This step may be omitted depending on a case and the learning can be begun from the conceptual contents. If it is determined that the learning will be performed from the conceptual contents, a learning procedure table is automatically written (S2350) by applying the previously set conceptual contents, the degree of difficulty of the problems and the number of the previously set problems learned per one times (S2320, S2330 and S2340).

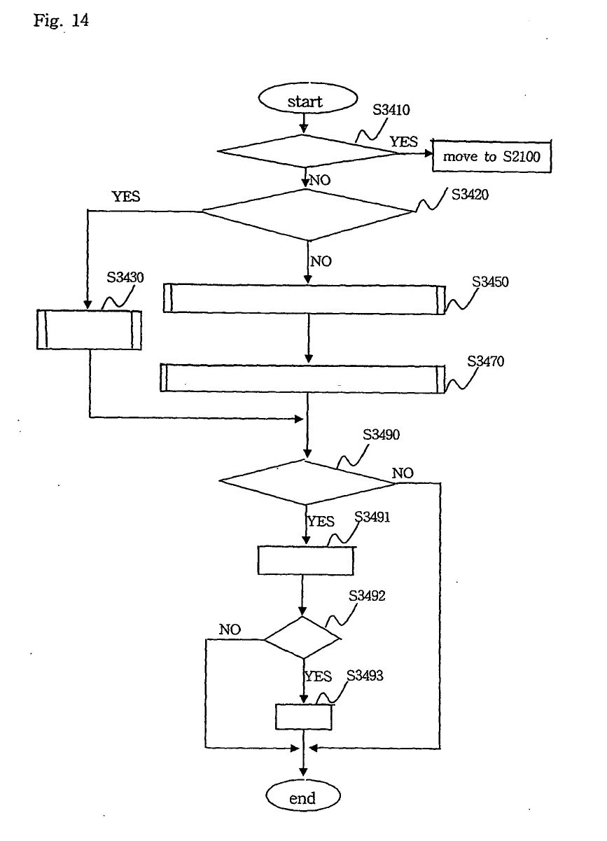

In FIG. 11 and FIG. 12, the contents of the learning procedure table shown in FIG. 11-1 may be an adequate example of the step of setting the learning range, the learning target, the start of the learning, the degree of difficulty of the conceptual contents and problems, the number of problems to be learned per one times, etc. 5, 6 and 7 items in FIG. 11-1 are contents that will be set in a process of reconfiguring next step learning contents in FIG. 14. As in FIG. 11-1, however, although the number of the problems to be learned was not set in FIG. 11 and FIG. 12, it will be set by default.

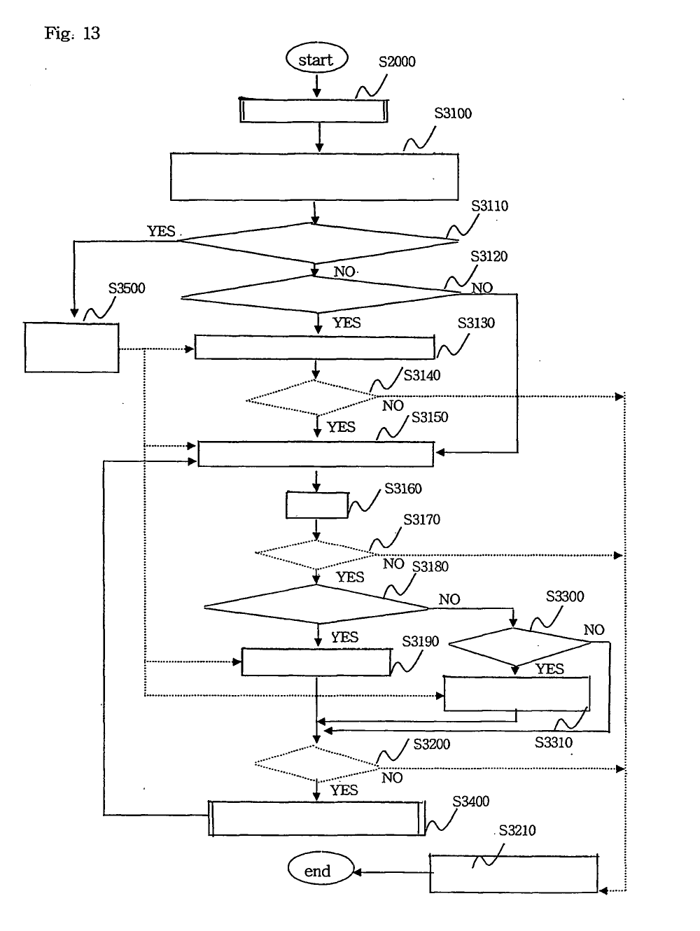

FIG. 13 is a flowchart illustrating the learning progress step according to a preferred embodiment of the present invention.

Referring to FIG. 13, according to the learning procedure set in the learning procedure-setting step (S2000), learning can start after moving learning data corresponding to the set learning range from a main storage space to a temporary storage space (S3100). Of course, if the contents of the learning are few or there is no need to move the learning data due to superior storage space and network ability, this step may not be necessary. The step of determining whether to progress the learning stopped in the past (S3110) and the step of determining whether to start the learning from the learning contents (S3120), are the contents that have already been shown in the learning procedure table since it were actually set in the learning procedure-setting step (S2000). However, the two steps were redundantly written in order to systematically explain the learning progress step. The learning progress step includes the step of allowing the learner to study the conceptual contents according to the learning procedure table (S3130) and then test problems (S3150), scoring the problems (S3160), allowing the learner to study wrong problems using the problem explanation files or related conceptual contents, and reconfiguring learning contents of a next step based on the level of knowledge for a conceptual content of a learner (S3400). This will be described in detail with reference to FIG. 14. In the learning progress step, the learning procedure may be stopped according to selection of the learner at any step. At this time, the learning procedure may be stopped after the learning contents are manually stored and may have an automatic storage function (S3210).

FIG. 14 is a flowchart illustrating a process of reconfiguring a next step learning content according to a preferred embodiment of the present invention in the context of FIG. 13.

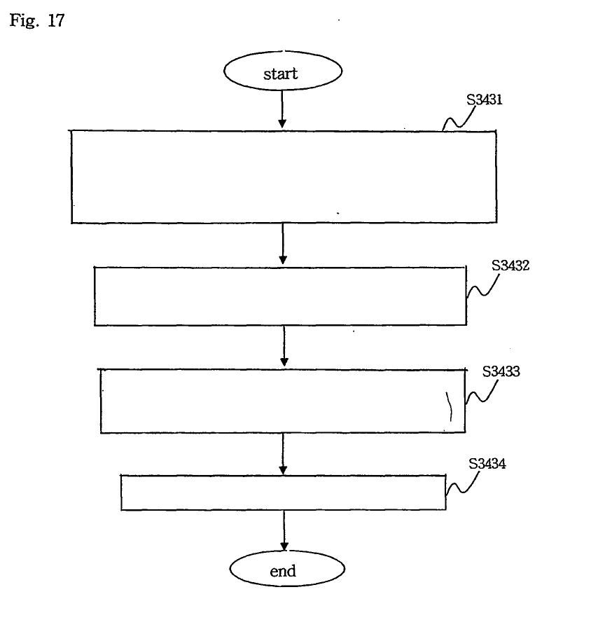

Referring to FIG. 14, after a series of learning is finished, it is determined whether the learning target has been reached (S3410). If the target was reached, it is determined whether the new learning of FIG. 11 is to be started (S2100). Meanwhile, if the target was not reached, the learning continues, wherein it is determined whether the problem reconfiguration will be automatically set (S3420). If the learner, etc. wants the problem reconfiguration automatic setting, the problem reconfiguration automatic setting step (S3430) is performed. This will be described in detail with reference to FIG. 17.

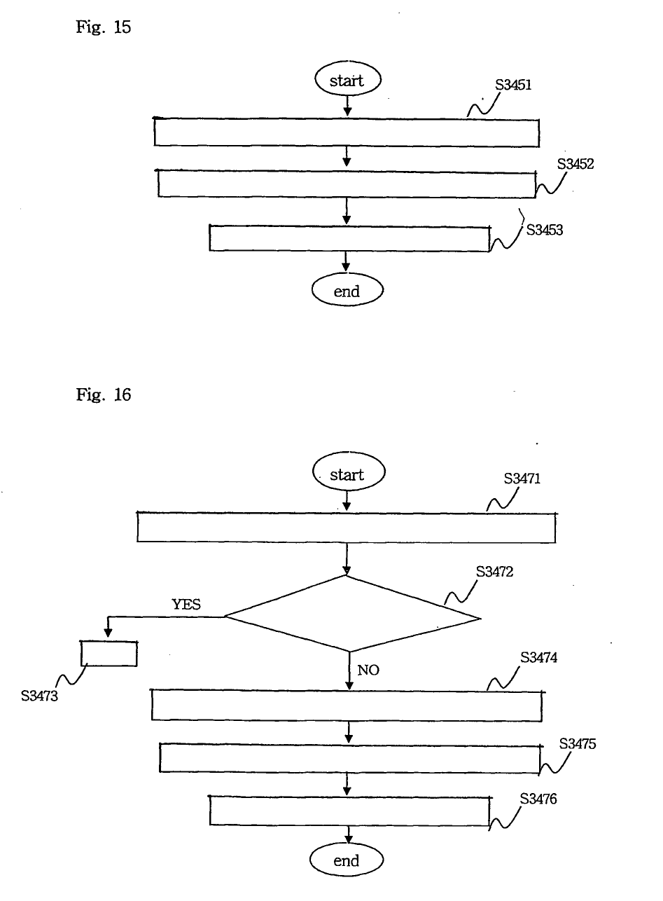

If the learner, etc. did not want the problem reconfiguration automatic setting, the learner experiences the step of reconfiguring the problems related to wrong problems (S3450) and the step of reconfiguring the problems related-to-the-problems (S3470). This will be described in detail with reference to FIG. 15 and FIG. 16.

Next, It is determined whether the learning procedure table depending on the set contents must be transmitted (S3490). If the learner, etc. wanted the learning procedure table to be sent, the learning procedure table is transmitted to the learner terminal, etc. (S3491). If the learner, etc. did not want the learning procedure table to be sent, the learner can modify the contents (S3492, S3493).

FIG. 15 is a flowchart illustrating a process of reconfiguring problems related to wrong problems according to a preferred embodiment of the present invention in the context of FIG. 14.

Referring to FIG. 15, the step of reconfiguring the problems related to the wrong problems includes the steps of setting the degree of difficulty of the reset problems related to the wrong problems, setting increase and decrease of the reset problems (S3451, S3452), and configuring corresponding problems depending on the set contents (S3453). How this can be set may be different depending on the learning contents and conditions. The contents of the items 5 and 6 of FIG. 11-1 may be one example.

FIG. 16 is a flowchart illustrating a process of reconfiguring problems related to hit problems according to a preferred embodiment of the present invention in the context of FIG. 14.

Referring to FIG. 16, the degree that the problems are solved, which is the basis for attaining the learning target for a conceptual content, is set (S3471). The learner, etc. can variously set the degree depending on the learning contents and conditions. The contents of the items 5 and 6 in FIG. 11-1 may be one example. Based on the set contents, it is determined whether the learning target for the hit problem has accomplished (S3472). The conceptual contents whose target was reached are excluded form the relearning object (S3473). The degree of difficulty of the reset problems related to the hit problems and is set, and increase and decrease of the reset problems are set for the conceptual contents whose learning targets were not accomplished (S3474, S3475). Corresponding problems are configured according to the set content (S3453). How this can be set may be varied depending on the learning contents and conditions. The contents of the items 5 and 6 in FIG. 11-1 may be one example.

FIG. 17 is a flowchart illustrating the process of automatically setting problem reconfiguration according to a preferred embodiment of the present invention in the context of FIG. 14.

Referring to FIG. 17, it is first automatically determined whether a learner reached a learning target for a hit problem based on the degree that problems are solved, which is the basis of accomplishing the learning target for previously set conceptual contents, and the conceptual contents whose targets are reached are excluded from re-learning subjects (S3431). The degree of difficulty of the reset problems related to the previously set wrong problems and increase and decrease of the reset problems are then automatically applied (S3432). The degree of difficulty of the reset problems related to the previously set hit problems and increase and decrease of the reset problems is automatically applied (S3433). Corresponding problems are automatically-configured according to the set contents (S3431). How this can be set may be changed depending on the learning contents and condition. Contents of the items 5, 6 and 7 in FIG. 11-1 may be one example.

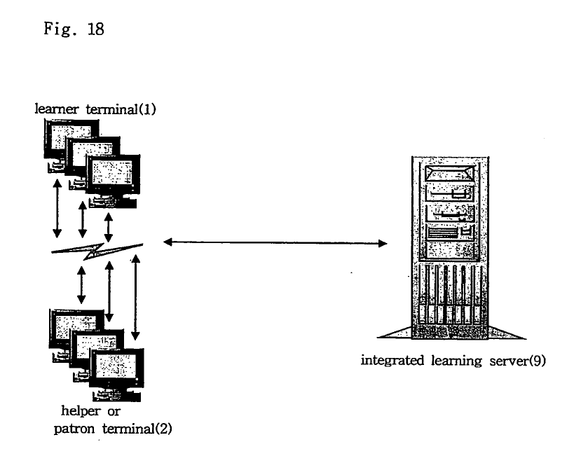

FIG. 18 illustrates the entire construction of an Internet learning system according to another embodiment of the present invention.

Referring to FIG. 18, an integrated learning server 9 is connected, through the Internet or the Intranet, to terminals 1, 2 of learners and learning-related persons such as a helper, a patron, etc. (hereinafter referred to as “learner, etc.”), which correspond to an interface in which the learner, the learning-related persons, etc. as shown in FIG. 1 access the system through the Internet.

The system shown in FIG. 1 consists of four server systems including the system operating server system 3, the learning information management server system 6, the learning progress server system 7 and the learning database server system 8. In FIG. 18, however, the single learning server 9 integrally manages the four server systems. Such a configuration can be used when the contents of the learning provided are relatively simple and a related database includes a small amount of information.

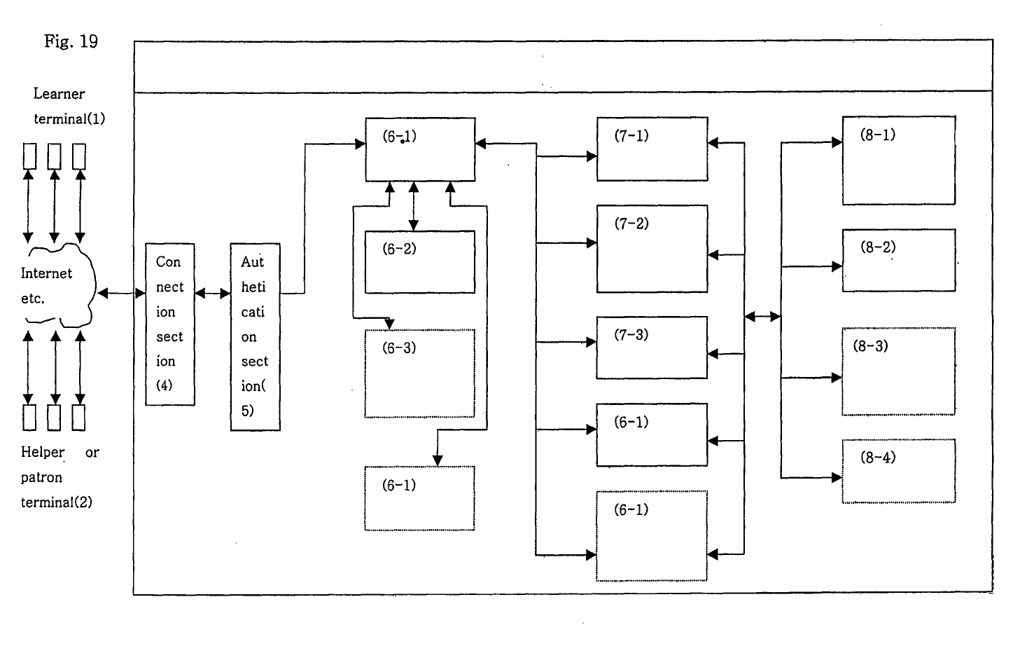

The integrated learning server 9 will now be described in more detail with reference to FIG. 19. The server 9 includes basically the connection section 4 and the authentication section 5. The connection section 4 and the authentication section 5 constituting the integrated learning server 9 are technical components that have currently been employed by lots of the Internet sites. The present invention may employ these well-known means.

The integrated teaming server 9 includes the learning information management program 6-1 and the learning information database 6-2, and may further include the learner learning ability measurement program 6-3 and the learning note management program 6-4, if needed. The integrated learning server 9 further includes the conceptual contents configuration program 7-2, the problem configuration program 7-3, the test scoring program 7-4 and the problem explanation file configuration program 7-5, and may further include the learning plan configuration program 7-1, if necessary.

Furthermore, the integrated learning server 9 includes the conceptual contents database 8-1, the problem database 8-2 and the problem explanation file database 8-3, and may further include the learning dictionary database 8-4, if necessary.

Therefore, all the integrated functions are provided to the learner terminal 1 and the helper or patron terminal 2 by means of the single server 9.

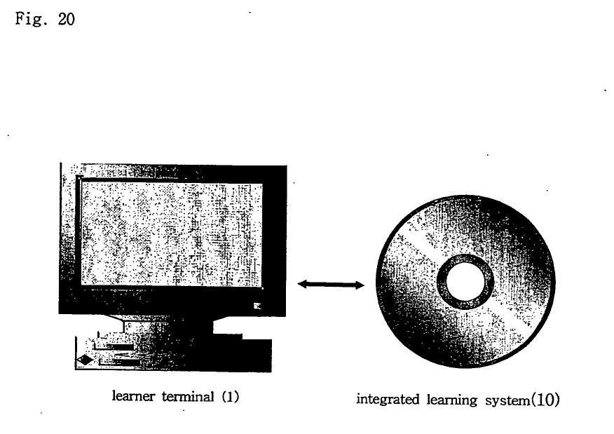

FIG. 20 illustrates the entire construction of an Internet learning system according to still another embodiment of the present invention.

Referring to FIG. 20, the constructions of the mentioned learning systems are constructed off-line not on-line. That is, the integrated learning system 10 is provided to the terminals 1 and 2 of the learner and the learning-related persons (hereinafter referred to as “learner, etc.”) as computer recordable/reproducible mediums such as a CD, a hard disk, etc.

The system shown in FIG. 1 consists of four server systems including the system operating server system 3, the learning information management server system 6, the learning progress server system 7 and the learning database server system 8. However, in FIG. 20, those four server systems in FIG. 1 are provided as the computer recordable/reproducible mediums such as the CD, the hard disk, etc. This configuration can be employed when the contents of learning provided are relatively simple and a related database includes a small amount of information.

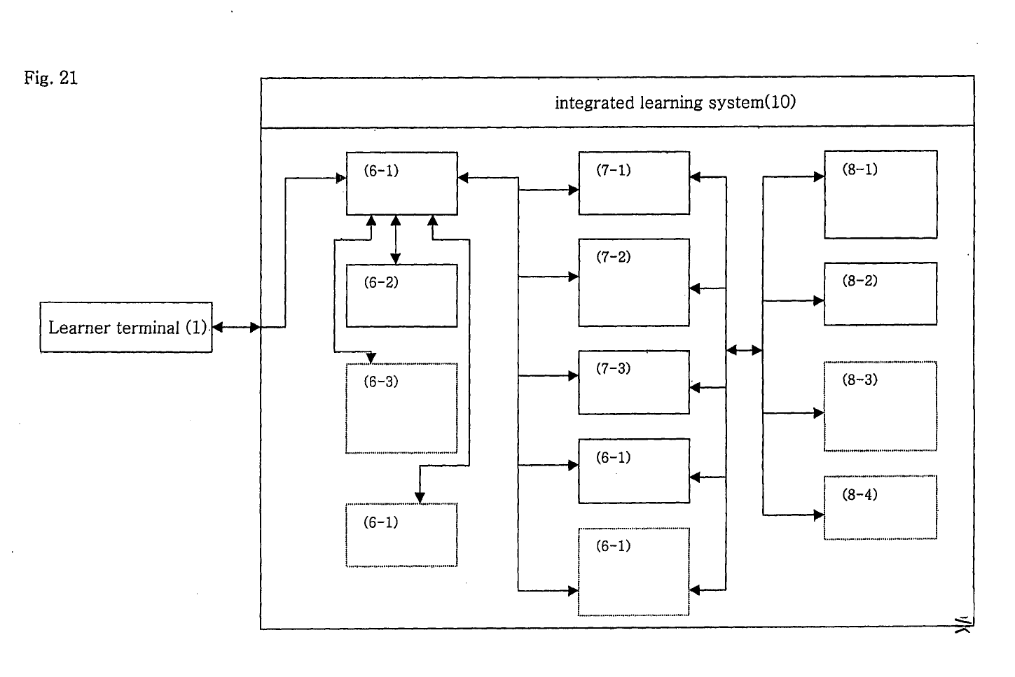

The integrated learning system 10 that is provided as the computer recordable/reproducible mediums such as the CD, the hard disk, etc. will now be described in more detail with reference to FIG. 21. The connection section 4 and the authentication section 5 that are basically used in an on-line mode, may not be usually used.

The integrated learning system 10 includes the learning information management program 6-1 and the learning information database 6-2, and may further include the learner learning ability measurement program 6-3 and the learning note management program 6-4, if needed. The integrated learning system 10 includes the conceptual contents configuration program 7-2, the problem configuration program 7-3, the test scoring program 7-4 and the problem explanation file configuration program 7-5, and may further include the learning plan configuration program 7-1, if necessary.

Furthermore, the integrated learning system 10 includes the conceptual contents database 8-1, the problem database 8-2 and the problem explanation file database 8-3, and may further include the learning dictionary database 8-4, if necessary.

Therefore, all the integrated functions are provided to the learner terminal 1 and the helper or patron terminal 2 as the computer recordable/reproducible mediums such as the CD, the hard disk, etc. by means of the integrated learning system 10.

### INDUSTRIAL APPLICABILITY

As described above, according to the present invention, a learner can concentrate more in the stuffy of portions that are lack or unknown as if the learner gets a lesson from a private teacher. Portions whose targets are reached are excluded from learning subjects. With respect to portions whose concept is understood but whose targets are not reached, the learner is provided with problems having a high-degree of difficulty and problem explanation files, so that the learner can repeatedly restudy those portions until the target level is reached. Regarding portions even whose concepts are not understood, the learner is repeatedly given with problems having an adequate level of conceptual contents and degree of difficulty and the problem explanation files, so that the ability of the learner can be improved to the target level; Therefore, it is possible to know in detail the degree that the learner understands learning contents. Further, as only necessary learning content is provided, the learner can obtain the maximum learning effect with the minimum time.

Next, the present invention has a function that a private teacher seems to directly teach the learner about unknown portions by the side. Important header data of the learning contents are listed in the conceptual contents and the problem explanation file. If the learner presses corresponding header data, the conceptual contents or a corresponding page of a learning dictionary describing the header data is indicated.

Thereafter, all the learning progresses are designed so that the learner can easily and conveniently use them. For this, it is preferred that the conceptual contents and the problem explanation file are made as visual materials accompanied by sound explanation. Therefore, the learner can study by just clicking the conceptual contents or a group of the problem explanation files. Further, learning contents of a next step is automatically provided to the learner unless the learner selects to modify it. Therefore, the learner can study at any place where he or she can access the system.

Finally, a helper and a patron can share learning information contents of the learner.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. An Internet learning system, comprising:
terminals for allowing learning-related persons including a learner to access a corresponding educational service site through the Internet;
a system operating server having a connection section and an authentication section;
a learning information management server having a learning information management program for selectively storing learning information generated from a learning procedure in a learning information database and extracting learning information necessary for the learning procedure from the learning information database, and the learning information database in which personal learning information depots containing items related to a learner's history learned in the past and the learner's learning ability are databased;
a learning progress server shaving a conceptual contents configuration program, a problem configuration program, a test scoring program, a problem explanation file configuration program, and a learning plan configuration program for managing other programs within the learning progress server; and
a learning database server including a conceptual contents database to which respective conceptual contents belong and in which each of the concepts of a learning range is subdivided by the minimum unit so that they can be easily reconfigured, a problem database having problem groups in which two or more degrees of difficulty are divided every conceptual content of the conceptual contents database and having at least one problem every problem group, and a problem explanation file database for explaining each of the problems of the problem database.

2. The Internet learning system as claimed in claim 1, wherein the learning database server further comprises a learning dictionary database and/or the learning information management server further comprises a learning note management program and/or a learning ability measurement program.

3. The Internet learning system as claimed in claim 1, wherein the conceptual contents data of the conceptual contents database is a packet structure having a header wherein a classification code, a medium classification code of over 1 step, a code divided by the minimum unit and a conceptual contents file code are allocated with given bits.

4. The Internet learning system as claimed in claim 3, wherein the degree of difficulty code of the conceptual contents data is allocated with given bits to form the packet structure constituting the header.

5. The Internet learning system as claimed in claim 1, wherein the problem data of the problem database has the packet structure having a header in which a classification code, a medium classification code of over 1 step, a code divided by the minimum unit, a problem-native code and the degree of difficulty code are allocated with given bits.

6. The Internet learning system as claimed in claim 1, wherein problem explanation file data of the problem explanation file database has a packet structure having a header in which a classification code, a medium classification code of over 1 step, a code divided by the minimum unit and a problem explanation file native code are allocated with given bits.

7. The Internet learning system as claimed in claim 3, wherein the packet structure allocates the number of packet byte following the header in suit with the size of a corresponding learning content.

8. The Internet learning system as claimed claim 3, wherein some or all the header data having the same code in the packets for a database are provided to the learning progress server 7 in batch.

9. The Internet learning system as claimed in claim 1, wherein the header data related to the learning contents are induced on the learning content of each of the conceptual contents database and the problem explanation file database, and the header data are connected to related learning dictionary database or conceptual contents database, whereby if the learner selects the header data, a corresponding database is provided to the learner so that the learner can start learning immediately.

10. The Internet learning system as claimed in claim 1, wherein if automatic scoring as an objective problem and an yes or no problem is possible when the problems are scored the problems using the test scoring program, the problems are automatically scored, and if the problems are subjective problems for which automatic scoring is difficult, the learner or the learning assistant scores the problems and then inputs the scoring result, in a state where the basis of scoring of corresponding problems is stored at the learning data server.

11. The Internet learning system as claimed in claim 1, wherein the conceptual contents database includes two or more different description types of the concepts for a conceptual content.

12. The Internet learning system as claimed in claim 1, wherein the problems related to each conceptual content of the problem database has three to ten steps on the basis of the degree of difficulty.

13. The Internet learning system as claimed in claim 1, wherein a learning method inducing function is added to the learning plan configuration program.

14. The Internet learning system as claimed in claim 1, wherein the learning contents of the conceptual contents database and the problem explanation file database include sound such as voice, etc. and moving elements.

15. A learning method using an Internet learning system, comprising the steps of:
allowing a learner to enter a corresponding Internet learning site and then to access a learning system;
allowing the learner to input learning conditions such as a learning range, etc.;
allowing a learning information management program to analyze information related to learning such as the learner's learning history, a learning ability, etc. that are received from a learning information database and then to present an adequate learning progress sequence to the learner;
extracting/configuring necessary problems from a problem database through a problem configuration program and then presenting the configured problems to the learner for a test;
allowing a learning plan configuration program to manage the learning progress sequence in which some steps or previous steps or each step among a step of scoring the problems tested by the learner through a test scoring program are overlapped, and the learning contents; and
storing learning-related information generated in each of the steps in the learning information databases.

16. The learning method as claimed in claim 15, further comprising the step of before the learner studies the problems, extracting/configuring necessary conceptual contents from a conceptual contents database through a conceptual contents configuration program and then presenting the configured conceptual contents to the learner, etc., and/or the step of after the step of scoring the tested problems, extracting/configuring necessary problem explanation files from a problem explanation file databases through a problem explanation file configuration program and then presenting the configured files to the learner, etc. or simulate corresponding conceptual content.

17. The learning method as claimed in claim 15, wherein in a configuration of problems for a text that will be performed again in connection with a learning range after the learner tests the problems and then learned the problems, regarding hit problems in a just-before test, it is a principle that problems whose degrees of difficulty are increased among problems related to the same conceptual content are set again,
wherein the number of the problems to be set is gradually reduced or same, and if the learner reaches a target learning level by hitting the problems of the final degree of difficulty that is selected by the learner, etc. through repeated review, the problems are excluded from learning subjects, and
wherein regarding the wrong problems in the just-before test, problems are again seta and the number of the set problems is gradually increased or same, thus providing a change that the learner can repeat learning on unknown problems.

18. The Internet learning system as claimed in claim 1, wherein some or all of the system operating server system, the learning information management server system, the learning progress server and the learning data server are integrated and managed by a single learning server.

19. The Internet learning system as claimed in claim 1, wherein some or all of the system operating server system, the learning information management server system, the learning progress server and the learning data server are integrated and are then stored at a storage medium that can be utilized by the learner or a helper.

20. The Internet learning system as claimed in claim 2, wherein the conceptual contents data of the conceptual contents database is a packet structure having a header wherein a classification code, a medium classification code of over 1 step, a code divided by the minimum unit and a conceptual contents file code are allocated with given bits.

21. The Internet learning system as claimed in claim 2, wherein the problem data of the problem database has the packet structure having a header in which a classification code, a medium classification code of over 1 step, a code divided by the minimum unit, a problem-native code and the degree of difficulty code are allocated with given bits.

22. The Internet learning system as claimed in claim 2, wherein problem explanation file data of the problem explanation file database has a packet structure having a header in which a classification code, a medium classification code of over 1 step, a code divided by the minimum unit and a problem explanation file native code are allocated with given bits.

23. The Internet learning system as claimed in claim 4, wherein the packet structure allocates the number of packet byte following the header in suit with the size of a corresponding learning content.

24. The Internet learning system as claimed in claim 5, wherein the packet structure allocates the number of packet byte following the header in suit with the size of a corresponding learning content.

25. The Internet learning system as claimed in claim 6, wherein the packet structure allocates the number of packet byte following the header in suit with the size of a corresponding learning content.

26. The Internet learning system as claimed in claim 4, wherein some or all the header data having the same code in the packets for a database are provided to the learning progress server in batch.

27. The Internet learning system as claimed in claim 5, wherein some or all the header data having the same code in the packets for a database are provided to the learning progress server in batch.

28. The Internet learning system as claimed in claim 6, wherein some or all the header data having the same code in the packets for a database are provided to the learning progress server in batch.

29. The Internet learning system as claimed in claim 7, wherein some or all the header data having the same code in the packets for a database are provided to the learning progress server in batch.

30. The Internet learning system as claimed in claim 2, wherein the header data related to the learning contents are induced on the learning content of each of the conceptual contents database and the problem explanation file database, and the header data are connected to related learning dictionary database or conceptual contents database, whereby if the learner selects the header data, a corresponding database is provided to the learner so that the learner can start learning immediately.

31. The Internet learning system as claimed in claim 2, wherein if automatic scoring as an objective problem and an yes or no problem is possible when the problems are scored the problems using the test scoring program, the problems are automatically scored, and if the problems are subjective problems for which automatic scoring is difficult, the learner or the learning assistant scores the problems and then inputs the scoring result, in a state where the basis of scoring of corresponding problems is stored at the learning data server.

32. The Internet learning system as claimed in claim 2, wherein the conceptual contents database includes two or more different description types of the concepts for a conceptual content.

33. The Internet learning system as claimed in claim 2, wherein the problems related to each conceptual content of the problem database has three to ten steps on the basis of the degree of difficulty.

34. The Internet learning system as claimed in claim 2, wherein a learning method inducing function is added to the learning plan configuration program.

35. The Internet learning system as claimed in claim 2, wherein the learning contents of the conceptual contents database and the problem explanation file database include sound such as voice, etc. and moving elements.

36. The learning method as claimed in claim 16, wherein in a configuration of problems for a text that will be performed again in connection with a learning range after the learner tests the problems and then learned the problems, regarding hit problems in a just-before test, it is a principle that problems whose degrees of difficulty are increased among problems related to the same conceptual content are set again,
wherein the number of the problems to be set is gradually reduced or same, and if the learner reaches a target learning level by hitting the problems of the final degree of difficulty that is selected by the learner, etc. through repeated review, the problems are excluded from learning subjects, and
wherein regarding the wrong problems in the just-before test, problems are again seta and the number of the set problems is gradually increased or same, thus providing a change that the learner can repeat learning on unknown problems.

37. The Internet learning system as claimed in claim 2, wherein some or all of the system operating server system, the learning information management server system, the learning progress server and the learning data server are integrated and managed by a single learning server.

38. The Internet learning system as claimed in claim 2, wherein some or all of the system operating server system, the learning information management server system, the learning progress server and the learning data server are integrated and are then stored at a storage medium that can be utilized by the learner or a helper.
